(19) United States
(12) Patent Application Publication
(10) Pub. No.: US 2015/0017040 A1
(43) Pub. Date: Jan. 15, 2015

(54) PULSATION DAMPER AND HIGH-PRESSURE PUMP HAVING THE SAME

(71) Applicant: DENSO CORPORATION, Kariya-city (JP)

(72) Inventors: Osamu HISHINUMA, Toyota-city (JP); Noriya MATSUMOTO, Okazaki-city (JP); Hiroatsu YAMADA, Nagoya-city (JP)

(21) Appl. No.: 14/322,067

(22) Filed: Jul. 2, 2014

(30) Foreign Application Priority Data
Jul. 12, 2013 (JP) 2013-146389
Jul. 12, 2013 (JP) 2013-146390
Jul. 12, 2013 (JP) 2013-146391

(51) Int. Cl. F04B 11/00; F02M 59/02

(52) U.S. Cl. CPC F04B 11/00; F02M 59/02
USPC 417/540

(57) ABSTRACT

A pulsation dumper configured to reduce a fuel pressure pulsation of fuel flowing in a fuel chamber includes a sealed space in which gas having a predetermined pressure is encapsulated between a first diaphragm and a second diaphragm configured to be resiliently deformable by a fuel pressure pulsation in the fuel chamber. A first resilient member provided in the sealed space abuts against an inner wall of the first diaphragm, and a second resilient member abuts against an inner wall of a second diaphragm. A supporting member provided between the first resilient member and the second resilient member supports an outer peripheral portion of the first resilient member and an outer peripheral portion of the second resilient member. A resonance of first and second diaphragms is restrained by the first and second resilient members. The first and second resilient members do not impair deformation of center portions of the first and second diaphragms.

### CROSS-REFERENCE TO RELATED APPLICATION

This application is based on Japanese Patent Applications No. 2013-146389 filed on Jul. 12, 2013, No. 2013-146390 filed on Jul. 12, 2013 and No. 2013-146391 filed on Jul. 12, 2013, the disclosures of which are incorporated herein by reference.

### TECHNICAL FIELD

This disclosure relates to a pulsation damper configured to reduce a pressure pulsation of fuel and a high-pressure pump having such a pulsation damper.

### BACKGROUND OF THE INVENTION

In the related art, a high-pressure pump configured to pressurize fuel by a reciprocal movement of a plunger is known.

The high-pressure pump includes a pulsation damper in a fuel chamber that communicates with a pump chamber in which fuel is pressurized. The pulsation damper is configured by joining outer peripheries of two diaphragms, and includes a sealed space in which gas at a predetermined pressure is encapsulated inside thereof. The pulsation damper reduces a pressure pulsation of fuel in a fuel supply system including the fuel chamber and a fuel piping that communicates therewith by displacement of the two diaphragms toward and away from each other depending on a pressure of the fuel.

In a pulsation damper described in Japanese Patent No. 4530053, a resin film as a weight adding member is adhered only to an inner wall of one of the diaphragms with an adhesive agent. In this configuration, a natural vibration frequency of one diaphragm and a natural vibration frequency of the other diaphragm are differentiated. Therefore, a vibration transmitted from an internal combustion engine, a vibration transmitted from an electromagnetic valve of the high-pressure pump, or a high-frequency pulsation of fuel in the fuel chamber do not match the natural vibration frequencies of the both diaphragms simultaneously. Therefore, the pulsation damper is configured to restrain a resonance of the vibrations as described above with the vibrations of the diaphragms.

However, in the pulsation damper described in Japanese Patent No. 4530053, since a resin film is adhered to the diaphragm with the adhesive agent, if the resin film is separated due to deterioration with time of the adhesive agent, the above described restraint of the resonance may become difficult.

### SUMMARY

This disclosure is intended to provide a pulsation damper configured to be capable of restraining resonance of diaphragms and maintaining a pressure pulsation damping performance of fuel, and a high-pressure pump having the same.

According to a first aspect of the present disclosure, a pulsation damper has a first diaphragm, a second diaphragm, a first resilient member, a second resilient member and a supporting member. The first diaphragm is configured to be resiliently deformable by a pressure pulsation of a fuel in a fuel chamber. The second diaphragm is configured to define a sealed space in which a gas having a predetermined pressure is encapsulated in cooperation with the first diaphragm in such a manner as to be resiliently deformable by the pressure pulsation of the fuel in the fuel chamber. The first resilient member is provided in the sealed space and configured to abut against an inner wall of the first diaphragm. The second resilient member is provided in the sealed space and configured to abut against an inner wall of the second diaphragm. The supporting member is provided between the first resilient member and the second resilient member in such a manner as to support an outer peripheral portion of the first resilient member and an outer peripheral portion of the second resilient member.

According to a second aspect of the present disclosure, a pulsation damper has a first diaphragm configured to be resiliently deformable by the pressure pulsation of the fuel in the fuel chamber, a second diaphragm configured to define a sealed space in which a gas having a predetermined pressure is encapsulated in cooperation with the first diaphragm. The second diaphragm is configured to be resiliently deformable by the pressure pulsation of the fuel in the fuel chamber. The pulsation damper further has a first inscribed member provided in the sealed space. The first inscribed member includes a first resilient portion configured to abut an inner wall of the first diaphragm, a second resilient portion configured to abut against an inner wall of the second diaphragm, and a first supporting portion configured to support an outer peripheral portion of the first resilient portion and an outer peripheral portion of the second resilient portion. The pulsation damper further has a second inscribed member including a third resilient portion configured to abut against an inner wall of the first diaphragm, a fourth resilient portion configured to abut against an inner wall of the second diaphragm, and a second supporting portion configured to support an outer peripheral portion of the third resilient portion and an outer peripheral portion of the fourth resilient portion. The second inscribed member is configured to be combined with the first inscribed member in the radial direction of the pulsation damper and provided in the sealed space.

According to a third aspect of the present disclosure, a pulsation damper has a first diaphragm configured to be resiliently deformable by the pressure pulsation of the fuel in the fuel chamber, a second diaphragm configured to define a sealed space in which gas having a predetermined pressure is encapsulated in cooperation with the first diaphragm. The second diaphragm is configured to be resiliently deformable by the pressure pulsation of the fuel in the fuel chamber. The pulsation damper further has a resonance restraining device integrally including a base plate provided in the sealed space, and a plurality of resilient ribs extending from the base plate in such a manner as to press an inner wall of the first diaphragm and an inner wall of the second diaphragm.

### BRIEF DESCRIPTION OF DRAWINGS

The above and other objects, features and advantages of the present disclosure will become more apparent from the following detailed description made with reference to the accompanying drawings. In the drawings:

FIG. 1 is a cross-sectional view of a high-pressure pump of a first embodiment;

FIG. 2 is a cross-sectional view of a pulsation damper provided in the high-pressure pump of the first embodiment;

FIG. 3 is an exploded view of a first resilient member, a second resilient member, and a supporting member provided in the pulsation damper of the first embodiment;

FIGS. 4A and 4B are schematic diagrams illustrating a state in which a pulsation damper of a comparative example resonates;

FIG. 5 is a cross-sectional view of a pulsation damper of a second embodiment;

FIG. 6 is an exploded view of a first resilient member, a second resilient member, and a supporting member provided in the pulsation damper of the second embodiment;

FIG. 7 is a cross-sectional view of a pulsation damper of a third embodiment;

FIG. 8 is an exploded view of a first resilient member, a second resilient member, and a supporting member provided in the pulsation damper of the third embodiment;

FIG. 9 is a cross-sectional view of a pulsation damper of a fourth embodiment;

FIG. 10 is an exploded view of a first resilient member, a second resilient member, and a supporting member provided in the pulsation damper of the fourth embodiment;

FIG. 11 is a cross-sectional view of a pulsation damper of a fifth embodiment;

FIG. 12 is an exploded view of a first resilient member, a second resilient member, and a supporting member provided in the pulsation damper of the fifth embodiment;

FIG. 13 is a cross-sectional view of a pulsation damper of a sixth embodiment;

FIG. 14 is an exploded view of a first resilient member, a second resilient member, and a supporting member provided in the pulsation damper of the sixth embodiment;

FIG. 15 is a cross-sectional view of a pulsation damper of a seventh embodiment;

FIG. 16 is an exploded view of a first resilient member, a second resilient member, and a supporting member provided in the pulsation damper of the seventh embodiment;

FIG. 17 is a cross-sectional view of a pulsation damper of an eighth embodiment;

FIG. 18 is an exploded view of a first resilient member, a second resilient member, and a supporting member provided in the pulsation damper of the eighth embodiment;

FIG. 19 is a cross-sectional view of a pulsation damper of a ninth embodiment;

FIG. 20 is an exploded view of a first resilient member, a second resilient member, and a supporting member provided in the pulsation damper of the ninth embodiment;

FIG. 21 is a cross-sectional view of a pulsation damper provided in the high-pressure pump of the tenth embodiment;

FIG. 22 is a cross-sectional view taken along a line XXII-XXII in FIG. 21;

FIG. 23 is an exploded view of a first inscribed member, a second inscribed member provided in the pulsation damper of the tenth embodiment;

FIG. 24 is a cross-sectional view of a pulsation damper of an eleventh embodiment;

FIG. 25 is a cross-sectional view taken along a line XXV-XXV in FIG. 24;

FIG. 26 is an exploded view of a first inscribed member and a second inscribed member provided in the pulsation damper of the eleventh embodiment;

FIG. 27 is a cross-sectional view of a pulsation damper of a twelfth embodiment;

FIG. 28 is a cross-sectional view taken along a line XXVIII-XXVIII in FIG. 27;

FIG. 29 is an exploded view of a first inscribed member, a second inscribed member, and a third inscribed member provided in the pulsation damper of the twelfth embodiment;

FIG. 30 is a cross-sectional view of a pulsation damper of a thirteenth embodiment;

FIG. 31 is a cross-sectional view taken along a line XXXI-XXXI in FIG. 30;

FIG. 32 is an exploded view of a first inscribed member and a second inscribed member provided in the pulsation damper of the thirteenth embodiment.

FIG. 33 is an exploded perspective view of the first inscribed member and the second inscribed member taken along a line XXXIII-XXXIII in FIG. 30;

FIG. 34 is a cross-sectional view of a pulsation damper of a fourteenth embodiment;

FIG. 35 is a cross-sectional view of a resonance restraining device of the fourteenth embodiment;

FIG. 36 is a cross-sectional view in a direction XXXVI in FIG. 35;

FIG. 37 is a cross-sectional view of a pulsation damper of a fifteenth embodiment;

FIG. 38 is a cross-sectional view of a resonance restraining device of the fifteenth embodiment;

FIG. 39 is a cross-sectional view in a direction XXXIX in FIG. 38;

FIG. 40 is a cross-sectional view of a pulsation damper of a sixteenth embodiment;

FIG. 41 is a cross-sectional view of a resonance restraining device of the sixteenth embodiment;

FIG. 42 is a cross-sectional view in a direction XLII in FIG. 41;

FIG. 43 is a cross-sectional view of a pulsation damper of a seventeenth embodiment;

FIG. 44 is a cross-sectional view of a resonance restraining device of the seventeenth embodiment; and

FIG. 45 is a cross-sectional view in a direction XLV in FIG. 44.

### DETAILED DESCRIPTION

Referring now to the drawings, embodiments of this disclosure will be described.

### First Embodiment

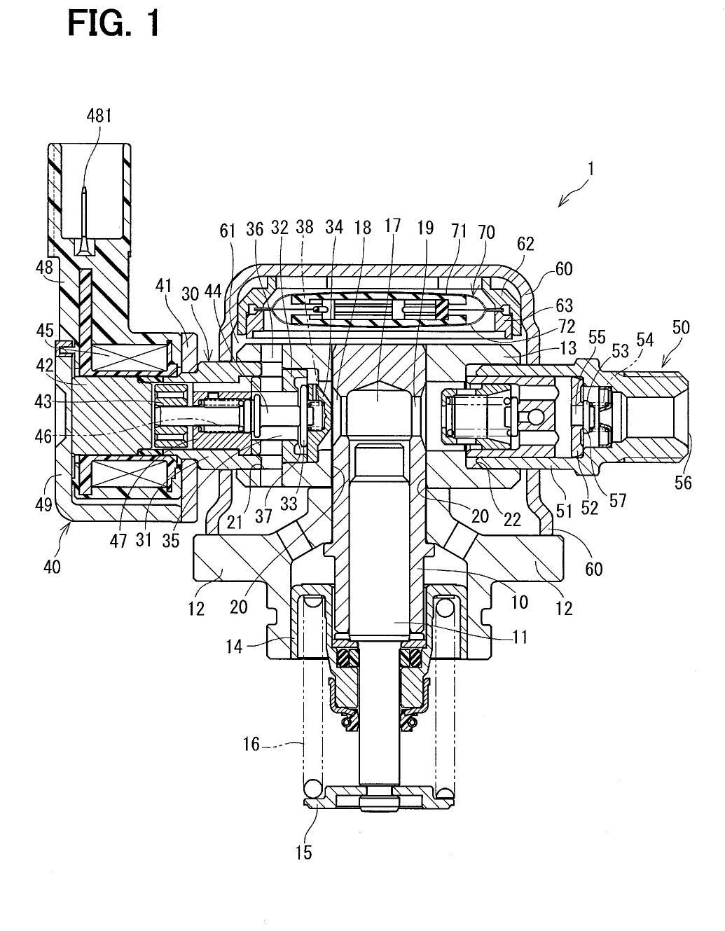

A first embodiment is illustrated in FIG. 1 to FIG. 3. A high-pressure pump 1 of the first embodiment is configured to pressurize fuel pumped from a fuel tank, which is not illustrated, by a low-pressure pump, and discharge the same to a delivery pipe, which is not illustrated. The fuel accumulated in the delivery pipe is injected from an injector connected to the delivery pipe into respective cylinders of an internal combustion engine.

As illustrated in FIG. 1, the high-pressure pump 1 includes a cylinder 10, a plunger 11, a lower housing 12, an upper housing 13, a fuel supply portion 30, an electromagnetic drive unit 40, a fuel discharge portion 50, a cover 60, and a pulsation dumper 70.

The cylinder 10, the lower housing 12, the upper housing 13, and the cover 60 of the embodiment correspond to an example of a “pump body”.

The cylinder 10 is formed into a cylindrical shape, and includes the plunger 11 inside thereof so as to be capable of performing a reciprocal movement. The lower housing 12 and the upper housing 13 are fixed to an outer wall in an outward radial direction of the cylinder 10. The lower housing 12 is configured to be mountable in a mounting hole formed in the internal combustion engine, which is not illustrated.

A first spring 16 is provided between an oil seal holder 14 fixed to the lower housing 12 and a spring seat 15 fixed to a lower end portion of the plunger 11. The first spring 16 biases the plunger 11 toward a camshaft of the internal combustion engine, which is not illustrated. Therefore, the plunger 11 is capable of performing the reciprocal movement in an axial direction according to a profile of the camshaft.

A pump chamber 17 is defined between an upper end portion of the plunger 11 and an inner wall of the cylinder 10. The cylinder 10 includes an inlet hole 18 opening from the pump chamber 17 in one direction in a radial direction and a discharge hole 19 opening in the other direction.

The upper housing 13 is formed into a substantially parallelepiped shape, a hole 20 provided at a center is secured to the cylinder 10 in an oil-tight manner, and is fixed to an upper side of the lower housing 12. The upper housing 13 includes a fuel-supply-portion mounting hole 21 communicating with the inlet hole 18 of the cylinder 10, and a fuel-discharge-portion mounting hole 22 communicating with the discharge hole 19 of the cylinder 10.

The fuel supply portion 30 includes an inlet valve body 31, an inlet valve seat member 32, an inlet valve 33, and a stopper member 34.

The inlet valve body 31 is formed into a cylindrical shape, and is fixed to the fuel-supply-portion mounting hole 21 of the upper housing 13.

The inlet valve body 31 is provided with a cylindrical inlet valve seat member 32 on the cylinder side. The inlet valve seat member 32 includes an inlet chamber 35 inside thereof. The inlet chamber 35 communicates with a fuel chamber 61 positioned outside the upper housing through a hole 36 provided in the upper housing 13. The inlet valve seat member 32 includes a valve seat 37 at an opening of the inlet chamber 35 on the pump chamber side.

The inlet valve 33 is provided on the pump chamber side of the valve seat 37, and is configured to be capable of seating on or moving out from the valve seat 37. The inlet valve 33 comes into abutment with the stopper member 34 when the valve is opened.

A second spring 38 is provided between the stopper member 34 and the inlet valve 33. The second spring 38 biases the inlet valve 33 toward the valve seat.

An electromagnetic drive unit 40 includes a flange 41, a fixed core 42, a movable core 43, a rod 44, a coil 45, and a third spring 46.

The flange 41 is fixed to an outer wall of the inlet valve body 31. The movable core 43 is provided inside the inlet valve body 31 so as to be capable of performing the reciprocal movement. The rod 44 is fixed to a center of the movable core 43. A guide member 47 fixed inside the inlet valve body 31 supports the rod 44 so as to allow the reciprocal movement in the axial direction. The third spring 46 biases the movable core 43 and the rod 44 toward the pump chamber. The rod 44 is capable of pressing an inlet valve 33 toward the pump chamber.

The fixed core 42 is provided on the side opposite to the side where the pump chamber is provided with respect to the movable core 43 side, and the coil 45 is provided radially outside of the fixed core 42. When the coil 45 is energized through a terminal 481 of a connector 48, a magnetic flux flows through a magnetic circuit including the movable core 43, the fixed core 42, the flange 41, and a yoke 49, and the movable core 43 and the rod 44 are magnetically attracted toward the fixed core side against a biasing force of the third spring 46.

In contrast, when energization of the coil 45 is stopped, the magnetic flux flowing in the magnetic circuit described above is disappeared, and the movable core 43 and the rod 44 are biased toward the pump chamber by the third spring 46.

The fuel discharge portion 50 includes a discharge valve body 51, a discharge valve seat member 52, a discharge valve 53, and a fourth spring 54.

The discharge valve body 51 is formed into a cylindrical shape, and is fixed to the fuel-discharge-portion mounting hole 22. The discharge valve seat member 52 is fixed inside the discharge valve body 51. The discharge valve seat member 52 includes a flow channel 55, and a discharge valve seat 57 at an opening of the flow channel 55 on a fuel outlet port 56 side. The discharge valve 53 is capable of seating on and moving away from the discharge valve seat 57. The fourth spring 54 biases the discharge valve 53 toward the discharge valve seat 57.

The cover 60 is formed into a bottomed cylindrical shape, and is fixed to the lower housing 12 at an opening end thereof in a liquid-tight manner. The fuel chamber 61 in which fuel is filled is formed inside the cover 60. The cover 60 is provided with a fuel inlet, which is not illustrated. The fuel pumped up from the fuel tank, which is not illustrated, is supplied to the fuel inlet. Therefore, the fuel is supplied from the fuel inlet to the fuel chamber 61.

When the fuel is suctioned from the fuel chamber 61 into the pump chamber 17 by the reciprocal movement of the plunger 11, and the fuel is discharged from the pump chamber 17 to the fuel chamber 61, a pressure pulsation of the fuel is generated in the fuel chamber 61. In the following description, the pressure pulsation of the fuel is referred to as a fuel pressure pulsation.

The pulsation dumper 70 is provided inside the cover 60. The pulsation dumper 70 is disposed between the upper housing 13 and the cover 60 in a state in which an upper edge portion thereof is clamped between an upper fixing member 62 and a lower fixing member 63.

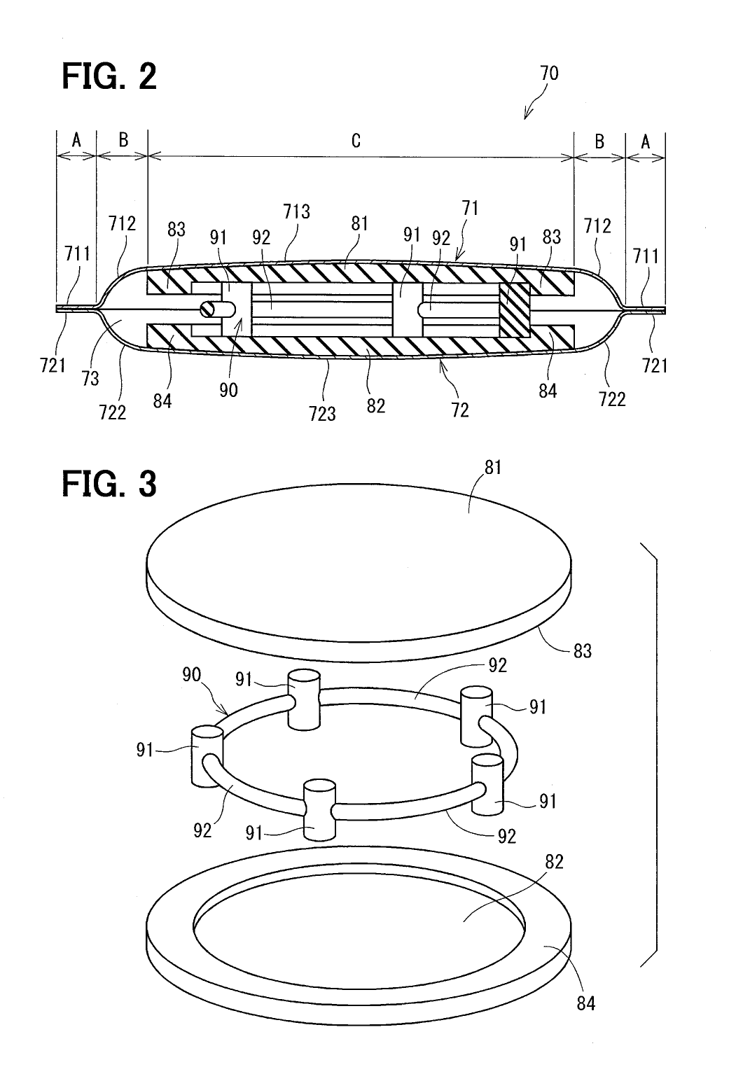

As illustrated in FIG. 2, the pulsation dumper 70 includes a first diaphragm 71, a second diaphragm 72, a first resilient member 81, a second resilient member 82, and a supporting member 90.

The first diaphragm 71 and the second diaphragm 72 are formed into a dish shape by pressing a metallic plate having a high-yield strength and a high-fatigue limit such as stainless steel.

The first diaphragm 71 integrally includes a first outer edge portion 711, a first curved surface portion 712 and a first damper portion 713. In FIG. 2, ranges of the first outer edge portion 711, the first curved surface portion 712, and the first damper portion 713 are shown by “A”, “B”, and “C”.

The first outer edge portion 711 is formed into a ring shape. The first curved surface portion 712 extends from the first outer edge portion 711 toward the second diaphragm 72, and is bent radially inward.

The first damper portion 713 is provided radially inside the first curved surface portion 712. The first damper portion 713 is larger in radius of curvature than the first curved surface portion 712, and is formed into a substantially flat shape.

The second diaphragm 72 integrally includes a second outer edge portion 721, a second curved surface portion 722, and a second damper portion 723. The configuration of the second diaphragm 72 is substantially the same as the configuration of the first diaphragm 71, so that the description is omitted.

The first damper portion 713 and the second damper portion 723 are not limited to have a flat shape, and may be, for example, a corrugated shape. The first diaphragm 71 and the second diaphragm 72 may have different shapes.

The pulsation dumper 70 has a configuration in which the first outer edge portion 711 of the first diaphragm 71 and the second outer edge portion 721 of the second diaphragm 72 are joined and gas having a predetermined pressure is sealed in a sealed space 73 inside thereof. The pulsation dumper 70 is configured to reduce the fuel pressure pulsation of the fuel chamber 61 by resiliently deforming center portions of two diaphragms 71 and 72 in the plate-thickness direction about center portions thereof depending on the fuel pressure in the fuel chamber 61.

The plate thickness, the material, the outer diameter, and the atmospheric pressure encapsulated in the sealed space 73 of the two diaphragms 71 and 72 are set as needed in accordance with durability or other required performances, so that a spring constant of the pulsation dumper 70 is determined. In addition, a frequency of the fuel pressure pulsation and a pulsation damping performance that the pulsation dumper 70 can reduce is determined on the basis of the spring constant.

The first resilient member 81 and the second resilient member 82 are made of, for example, rubber, urethane, or elastomer. The first resilient member 81 and the second resilient member 82 are provided in the sealed space 73. The first resilient member abuts against an inner wall of the first diaphragm 71, and the second resilient member abuts against an inner wall of the second diaphragm 72. The configuration of the first resilient member 81 and the configuration of the second resilient member 82 are substantially the same, and hence only the first resilient member 81 will be described.

In the embodiment disclosed, the first resilient member 81 abuts against the entire area of the first damper portion 713 from a connecting point between the first curved surface portion 712 and the first damper portion 713. The connecting point is a boundary between B and C illustrated in FIG. 2.

The first resilient member 81 needs only to abut against a major area of the first damper portion 713 from the vicinity of the connecting point between the first curved surface portion 712 and the first damper portion 713. The expression “the vicinity of the connecting point” is an area larger or smaller than a diameter of the connecting point, and corresponds to a range in which lowering of a resonance restraining performance by the resilient member is allowed.

If an outer diameter of the first resilient member 81 is smaller than the diameter of the connecting point, even when the position of the first resilient member 81 is displaced due to a tolerance at the time of assembly, such an event that the first resilient member 81 is pressed by the first curved surface portion 712 of the first diaphragm 71 and hence unintentional deformation of the first resilient member 81 occurs is prevented.

However, if the outer diameter of the first resilient member 81 is smaller than the diameter of the connecting point, the resonance restraining performance is lowered. Therefore, the first resilient member 81 preferably abuts against the first damper portion 713 over a range not smaller than 80% of the surface area thereof.

In contrast, if the shape of an outer peripheral portion of an end surface of the first resilient member 81 on the side of the first diaphragm matches the shape of the first curved surface portion 712 of the first diaphragm 71, the outer diameter of the first resilient member 81 may be larger than the diameter of the connecting point.

In the first diaphragm 71, the radius of curvature of the first curved surface portion 712 and the radius of curvature of the first damper portion 713 are different. Therefore, the first resilient member 81 is prevented from moving in the radial direction in the sealed space after the first resilient member 81 has been mounted in the sealed space by abutting against the vicinity of the connecting point.

The first resilient member 81 includes a first projecting portion 83 projecting in a ring shape toward the second resilient member in the plate-thickness direction. The second resilient member 82 includes a second projecting portion 84 projecting in a ring shape toward the first resilient member in the plate-thickness direction. The first projecting portion 83 and the second projecting portion 84 are both located radially outside the supporting member 90, so that the positional displacement in the radial direction of the supporting member 90 is prevented.

The supporting member 90 is formed, for example, of rubber, urethane, elastomer, resin, or metal, and is provided between the first resilient member 81 and the second resilient member 82. The supporting member 90 is preferably formed of the same material as the first resilient member 81 and the second resilient member 82 in a manufacturing cost point of view. The supporting member 90, the first resilient member 81 and the second resilient member 82 can be formed from different materials.

The supporting member 90 includes a plurality of supporting posts 91 and coupling portions 92 configured to connect a plurality of the supporting posts 91. A plurality of the supporting posts 91 are arranged along the outer peripheral portions of the first resilient member 81 and the second resilient member 82. The coupling portions 92 connect the supporting posts 91 in the circumferential direction of the pulsation dumper 70.

In the embodiment disclosed, the outer peripheral portion of the first resilient member 81 indicates a certain range of the inner side radially from the outer diameter of the first resilient member 81, and more specifically, an area radially inside the first projecting portion 83 where a plurality of the supporting posts 91 are arranged. The outer peripheral portion of the second resilient member 82 indicates a certain range of the inner side radially from the outer diameter of the second resilient member 82, and more specifically, an area radially inside the second projecting portion 84 where a plurality of the supporting posts 91 are arranged.

A plurality of the supporting posts 91 is formed to have a size which is the same as or a little bit larger than the length between the first resilient member 81 and the second resilient member 82. Therefore, a plurality of supporting posts 91 press the first resilient member 81 against the first damper portion 713, and the second resilient member 82 against the second damper portion 723. Accordingly, the first resilient member 81 abuts against the first damper portion 713 over the entire surface, and the second resilient member 82 abuts against the second damper portion 723 over the entire range, so that resonance of the pulsation dumper 70 is restrained. The first resilient member 81 and the second resilient member 82 are not supported at center portions thereof by the supporting posts 91. Therefore, the center portion can be deformed easily in the plate-thickness direction.

Subsequently, an action of the high-pressure pump 1 will be described.

### (1) Suction Stroke

When the plunger 11 moves from a top dead center toward a bottom dead center in response to the rotation of the cam shaft, a capacity of the pump chamber 17 is increased, and the pressure of the fuel is reduced. The discharge valve 53 is seated on the discharge valve seat 57, and closes the flow channel 55 thereof.

In contrast, the inlet valve 33 moves toward the pump chamber against a biasing force of the second spring 38 by a differential pressure between the pump chamber 17 and the inlet chamber 35. The inlet valve 33 is brought into a valve-open state.

By the opening motion of the inlet valve 33, the fuel in the fuel chamber 61 passes through the inlet chamber 35, and flows into the pump chamber 17.

When a fuel pressure in the fuel chamber 61 is lowered in the suction stroke, the pulsation dumper 70 is displaced in a direction in which the two diaphragms 71 and 72 move away from each other. In other words, the two diaphragms 71 and 72 are swelled in the plate-thickness direction about center portions of the damper portions 713, 723. Accordingly, the capacity of the fuel chamber 61 is reduced, and lowering of the fuel pressure in the fuel chamber 61 is restrained.

At this time, the first resilient member 81 and the second resilient member 82 are deformed so as to follow the displacement of the diaphragms 71 and 72 in a state of abutting against the inner walls of the two diaphragms 71 and 72.

### (2) Metering Stroke

When the plunger 11 moves from a bottom dead center toward a top dead center in response to the rotation of the cam shaft, the capacity of the pump chamber 17 is reduced. At this time, since the energization of the coil 45 is stopped to a predetermined timing, the rod 44 presses the inlet valve 33 toward the pump chamber by a biasing force of the third spring 46. Therefore, the inlet valve 33 is maintained in the valve-open state.

By the opening action of the inlet valve 33, the state in which the pump chamber 17 and the fuel chamber 61 communicate with each other is maintained. Therefore, the low pressure fuel suctioned into the pump chamber 17 once is returned to the fuel chamber 61, and the fuel pressure of the fuel chamber 61 is increased. In contrast, the pressure of the pump chamber 17 is not increased.

When the fuel pressure in the fuel chamber 61 is increased in the metering stroke, the pulsation dumper 70 is displaced in a direction in which the two diaphragms 71 and 72 move toward each other. In other words, the two diaphragms 71 and 72 are depressed in the plate-thickness direction about center portions of the damper portions 713, 723. Accordingly, the capacity of the fuel chamber 61 is increased, and an increase of the fuel pressure in the fuel chamber 61 is restrained.

At this time, the first resilient member 81 and the second resilient member 82 are deformed so as to follow the displacement of the diaphragms 71 and 72 in a state of abutting against the inner walls of the two diaphragms 71 and 72.

When the coil 45 is energized at a predetermined time in the midcourse when the plunger 11 moves upward from the bottom dead center to the top dead center, a magnetic attraction force is generated between the fixed core 42 and the movable core 43 by a magnetic field generated in the coil 45. When the magnetic attraction force is becomes larger than a differential force between a resilient force of the second spring 38 and a resilient force of the third spring 46, the movable core 43 moves toward the fixed core. Accordingly, a pressing force of the rod 44 with respect to the inlet valve 33 is released.

In addition, the inlet valve 33 moves in a valve-close direction by a resilient force of the second spring 38 and a dynamic pressure of the low pressure fuel discharged from the pump chamber 17 toward the inlet chamber so as to follow the action of the rod 44. Then the inlet valve 33 seats on the valve seat. Accordingly, the pump chamber 17 and the inlet chamber 35 are isolated.

### (3) Discharging Stroke

After the inlet valve 33 has closed, the fuel pressure in the pump chamber 17 is increased in association with the upward movement of the plunger 11. When a force of the fuel pressure in the pump chamber 17 acting on the discharge valve 53 becomes larger than a force of the fuel pressure on the fuel outlet port 56 side acting on the discharge valve 53 and a biasing force of the fourth spring 54, the discharge valve 53 opens. Accordingly, the high-pressure fuel pressurized in the pump chamber 17 is discharged from the fuel outlet port 56.

Energization of the coil 45 is stopped in the midcourse of the discharging stroke. Since the force of the fuel pressure in the pump chamber 17 acting on the inlet valve 33 is larger than the biasing force of the third spring 46, the inlet valve 33 is maintained in the valve-closed state.

The high-pressure pump 1 repeats the suction stroke, the metering stroke, and the discharging stroke, and presses and discharges the fuel by an amount required for the internal combustion engine.

The pulsation dumper 70 causes the two diaphragms 71 and 72 to be resiliently deformed about center portions of the damper portions 713, 723 in association with the fuel pressure pulsation of the fuel chamber 61, whereby the fuel pressure pulsation thereof is restrained. The first resilient member 81 and the second resilient member 82 abut against the inner wall of the two diaphragms 71 and 72 to restrain the resonance of the diaphragms 71 and 72.

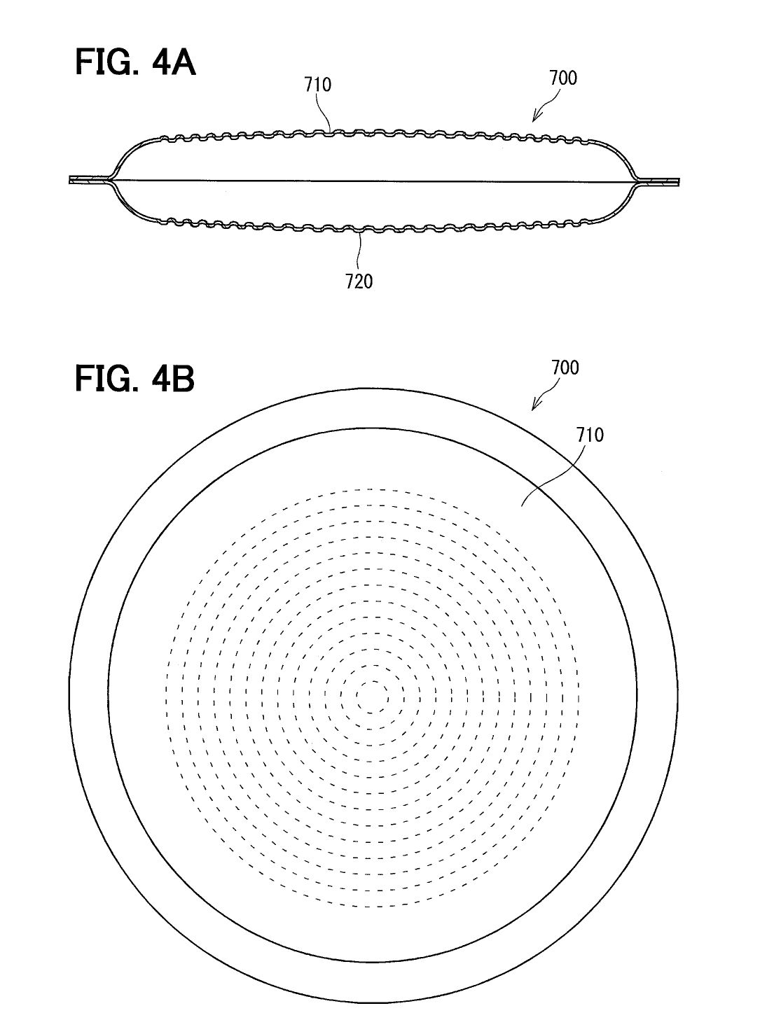

A pulsation damper 700 of a comparative example will be described with reference to FIGS. 4A and 4B.

The pulsation damper 700 of the comparative example is not provided with the first resilient member, the second resilient member, and the supporting member.

FIGS. 4A and 4B illustrate a schematic example of a state in which the pulsation damper 700 of the comparative example resonates with the vibrations in the periphery thereof. Examples of the vibrations in the periphery includes a vibration transmitted from an internal combustion engine, a vibration transmitted from an electromagnetic valve of a high-pressure pump 1, or a high-frequency pulsation of fuel in a fuel chamber 61. When these vibrations match the natural vibration frequencies of diaphragms 710 and 720, as illustrated in FIG. 4A, the diaphragms 710 and 720 vibrate finely by the resonance. The resonance is not limited to that illustrated in a concentric circle shown by a broken line as in FIG. 4B, and may be generated at a plurality of positions of the diaphragms 710 and 720 simultaneously, and these vibrations may be generated in an overlapped manner.

When the resonance occur in the pulsation damper 700, there is a fear that the vibration thereof are transmitted to the cover 60 or the like of the high-pressure pump 1 and a noise is generated. There is also a fear that the vibrations are transmitted through fuel piping or the like connected to a fuel inlet, and a noise is generated in a cabin or the like.

In contrast, the high-pressure pump 1 in the first embodiment has the following advantageous effects.

(1) In the first embodiment, the first resilient member 81 and the second resilient member 82 abut against the two diaphragms 71 and 72 in the sealed space in the pulsation dumper 70, and the supporting member 90 provided between the first resilient member 81 and the second resilient member 82 supports the outer peripheral portion of the first resilient member 81 and the outer peripheral portion of the second resilient member 82.

By the abutment between the first resilient member 81 and the second resilient member 82 with the inner walls of the two diaphragms 71 and 72, the resonance between the vibration transmitted from the internal combustion engine, the vibration transmitted from the electromagnetic valve, or the high-frequency pulsation of the fuel and the diaphragms 71 and 72 is restrained. Therefore, generation of the noise from the pulsation dumper 70 and the noise from the cover 60 of the high-pressure pump 1 may be restrained.

By the supporting member 90 supporting the outer peripheral portion of the first resilient member 81 and the outer peripheral portion of the second resilient member 82, the pulsation dumper 70 may maintain a pressure pulsation damping performance without impairing the deformation of the center portions of the diaphragms 71 and 72.

In addition, the first resilient member 81 and the second resilient member 82 are supported by the supporting member 90, and are not adhered to the diaphragms 71 and 72 with the adhesive agent. Thus, deterioration with time may be prevented.

(2) In the first embodiment, the first resilient member 81 abuts against a substantially entire area of the first damper portion 713 from the vicinity of the connecting point between the first curved surface portion 712 and the first damper portion 713. The second resilient member 82 abuts against a substantially entire area of the second damper portion 723 from the vicinity of the connecting point between the second curved surface portion 722 and the second damper portion 723.

Accordingly, since the first resilient member 81 and the second resilient member 82 come into abutment with the major part of the movable areas of the two diaphragms 71 and 72, the resonance between the diaphragms 71 and 72 is reliably restrained.

(3) In the first embodiment, the supporting member 90 is formed to have a size which is the same as or a little bit larger than the length between the first resilient member 81 and the second resilient member 82. Accordingly, the supporting member 90 presses the first resilient member 81 against the first diaphragm 71, and presses the second resilient member 82 against the second diaphragm 72. Therefore, the resonance of the diaphragms 71 and 72 is reliably restrained.

(4) In the first embodiment, the supporting member 90 includes a plurality of the supporting posts 91 arranged along the outer peripheral portions of the first resilient member 81 and the second resilient member 82, and coupling portions 92 configured to connect a plurality of the supporting posts 91 in the circumferential direction of the pulsation dumper 70.

Accordingly, a plurality of the supporting posts 91 are integrally coupled, so that a plurality of the supporting posts 91 can be assembled easily between the first resilient member 81 and the second resilient member 82. The positional displacement of a plurality of the supporting posts 91 may be prevented.

Also, gas encapsulated in the sealed space 73 is allowed to flow between a plurality of the supporting posts 91. Therefore, the pulsation dumper 70 is capable of maintaining the pressure pulsation damping performance.

(5) In the first embodiment, the first projecting portion 83 of the first resilient member 81 and the second projecting portion 84 of the second resilient member 82 prevent positional displacement in the radial direction of the supporting member 90.

Accordingly, the positional displacement in the radial direction of the supporting member 90 is prevented with a simple configuration.

(6) In the first embodiment, the supporting member 90 is formed of a resilient member.

Accordingly, the first resilient member 81 and the second resilient member 82 can be pressed reliably against the two diaphragms 71 and 72.

### Second Embodiment

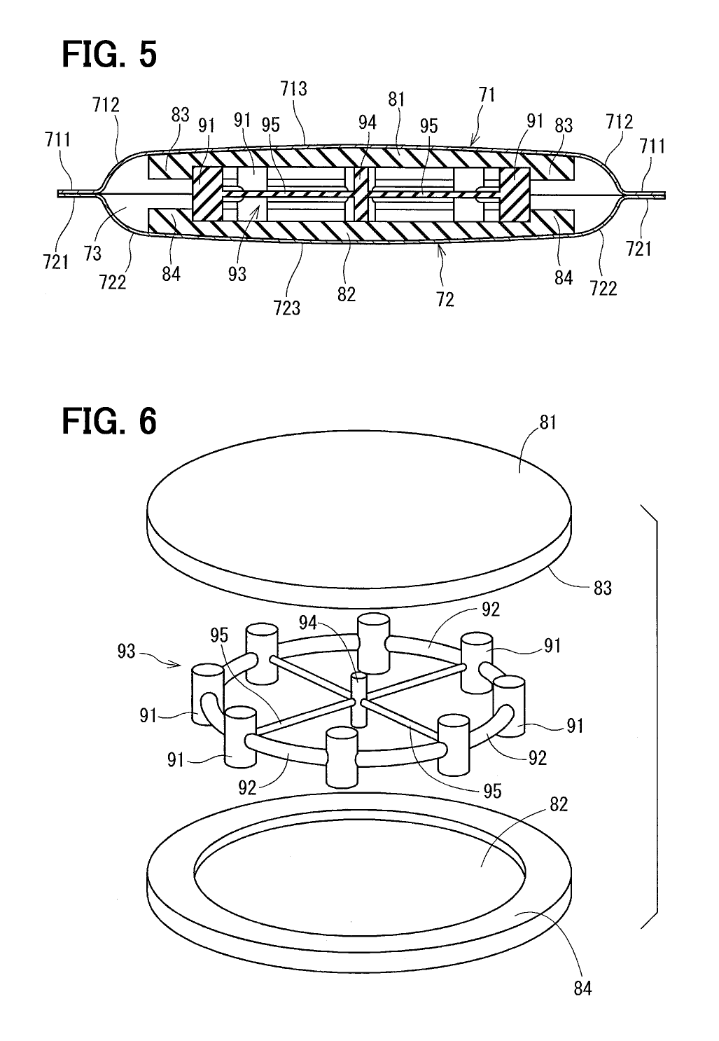

A second embodiment is illustrated in FIG. 5 and FIG. 6. Hereinafter, in a plurality of embodiments, substantially the same configurations as the first embodiment described above are denoted by the same reference signs, and the description will be omitted.

In the second embodiment, a supporting member 93 includes a supporting post 94 at a center portion of a pulsation dumper 70. With the supporting post 94 provided at the center, a first resilient member 81 and a second resilient member 82 abut reliably with a first diaphragm 71 and a second diaphragm 72.

The supporting post 94 at the center is formed of a resilient member such as elastomer. The supporting post 94 at the center is formed to be thinner than supporting posts 91 provided on the outside. Therefore, the resilient force of the supporting post 94 at the center is small to an extent that does not impair the displacement of the diaphragms 71 and 72 in the plate-thickness direction.

The supporting post 94 at the center and the supporting posts 91 on the outside are connected by second coupling portions 95. Therefore, assembly of the supporting member 93 is easy and the positional displacement of the supporting post 94 at the center is prevented.

In the second embodiment, the entire surface including a center portion of the first resilient member 81 abuts reliably with a first damper portion 713, and the entire surface including a center portion of the second resilient member 82 reliably abuts against the second damper portion 723, so that a resonance of the pulsation dumper 70 can be restrained.

The resilient force of the supporting post 94 at the center is small to an extent that does not impair the displacement of the diaphragms 71 and 72 in the plate-thickness direction. Therefore, damper portions 713, 723 are easily deformable in the plate-thickness direction. Therefore, the pulsation dumper 70 is capable of maintaining the pressure pulsation damping performance.

### Third Embodiment

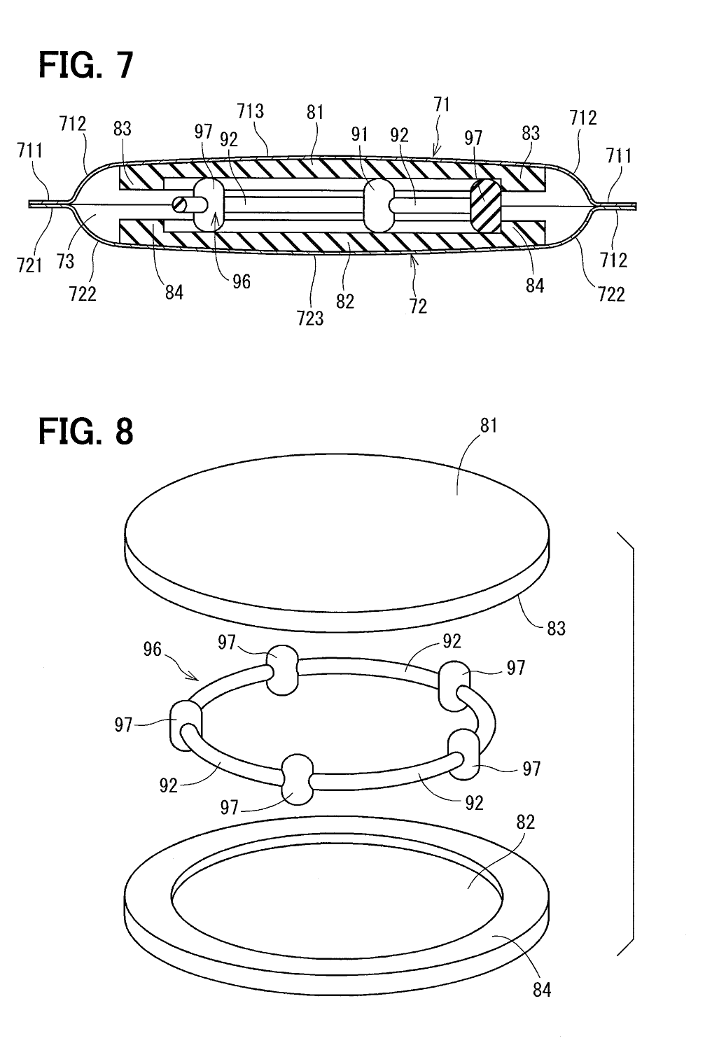

A third embodiment is illustrated in FIG. 7 and FIG. 8. In the third embodiment, a plurality of the supporting posts 97 is formed to have a semi-spherical end surface in an axial direction. Therefore, a first resilient member 81 and a second resilient member 82 are capable of resiliently deformable toward each other from radially inside of tops of a plurality of the supporting posts 97. Therefore, the first resilient member 81 and the second resilient member 82 are resiliently deformable easily toward each other. Therefore, a pulsation dumper 70 is capable of maintaining a pressure pulsation damping performance without impairing displacement of a first diaphragm 71 and a second diaphragm 72 by the first resilient member 81 and the second resilient member 82.

### Fourth Embodiment

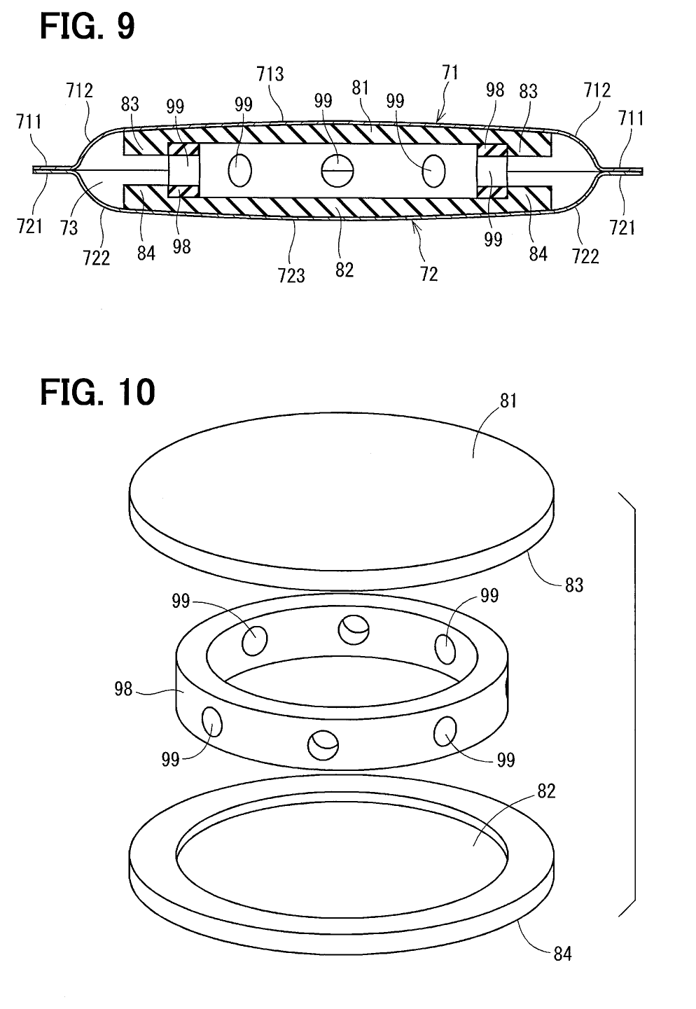

A fourth embodiment is illustrated in FIG. 9 and FIG. 10. In the fourth embodiment, a supporting member 98 is formed into a ring-shape along outer peripheral portions of a first resilient member 81 and a second resilient member 82. The supporting member 98 abuts against the outer peripheral portions of the first resilient member 81 and the second resilient member 82 continuously in the circumferential direction.

The supporting member 98 includes passages 99 that communicate a space radially inside the supporting member 98 in a sealed space 73 and a space radially outside the supporting member 98 in the sealed space 73.

In the fourth embodiment, by the supporting member 98 formed into a ring shape, the supporting member 98 is capable of providing a pressing force uniformly to the first resilient member 81 and the second resilient member 82.

In the fourth embodiment, since the supporting member 98 includes the passages 99, deformation of center portions of the two diaphragms 71 and 72 in the plate thickness direction is not impaired by an atmospheric pressure in the space radially inside the supporting member 98. Therefore, a pulsation dumper 70 is capable of maintaining a pressure pulsation damping performance.

### Fifth Embodiment

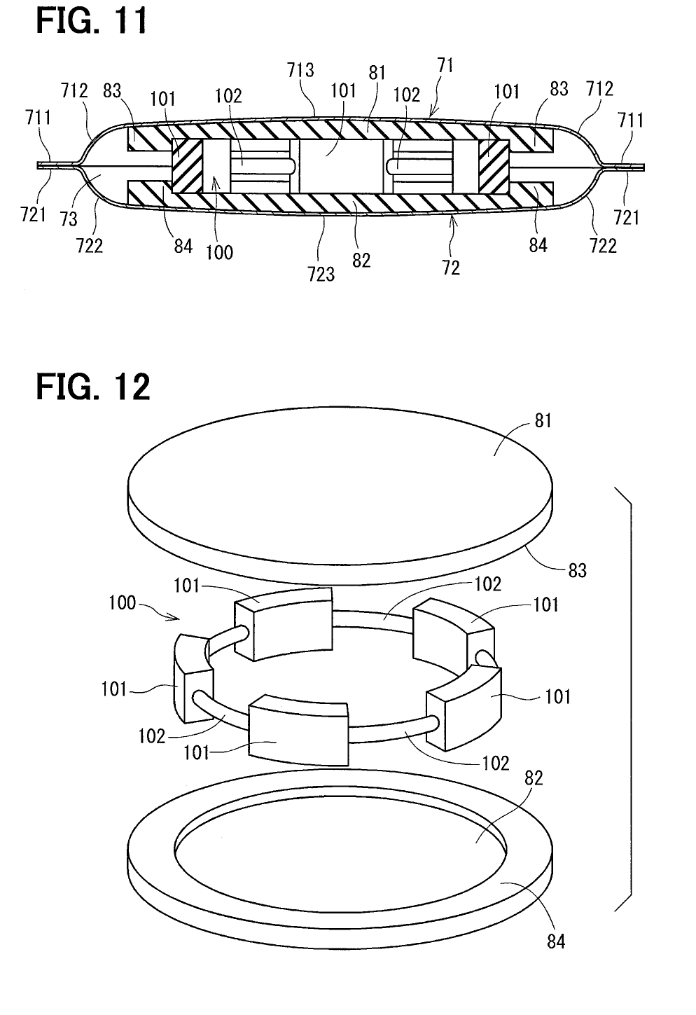

A fifth embodiment is illustrated in FIG. 11 and FIG. 12. In the fifth embodiment, a supporting member 100 includes a plurality of supporting posts 101 formed into an arcuate shape when viewed in an axial direction and coupling portions 102 connecting a plurality of the supporting posts 101 in the circumferential direction. A plurality of the supporting posts 101 are arranged along outer peripheral portions of a first resilient member 81 and a second resilient member 82. Also, gas encapsulated in a sealed space 73 is allowed to flow between a plurality of the supporting posts 101.

In the fifth embodiment, the same advantageous effects as the first to the fourth embodiments are achieved.

### Sixth Embodiment

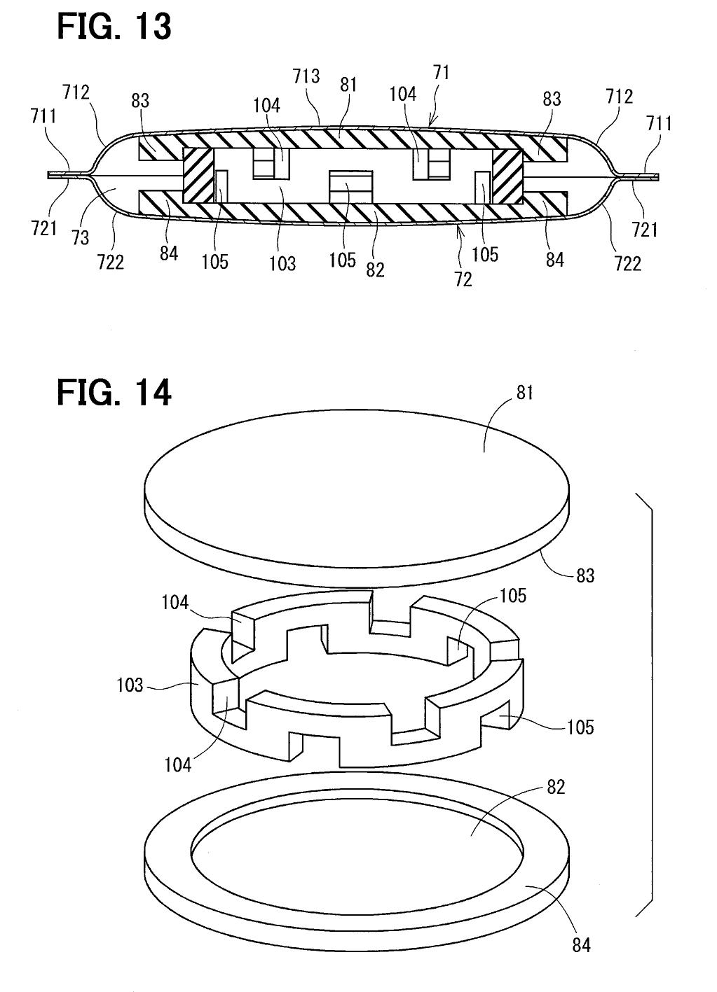

A sixth embodiment is illustrated in FIG. 13 and FIG. 14. In the sixth embodiment, a supporting member 103 is formed in a ring shape along an outer peripheral portions of a first resilient member 81 and ah second resilient member 82. A passage of the supporting member includes a first passage 104 provided on a first resilient member side in an axial direction and a second passage 105 provided on a second resilient member side in the axial direction. The first passage 104 and the second passage 105 are provided alternately in the circumferential direction of the supporting member 103.

In the sixth embodiment, the same advantageous effects as the first to the fifth embodiments are achieved.

### Seventh Embodiment

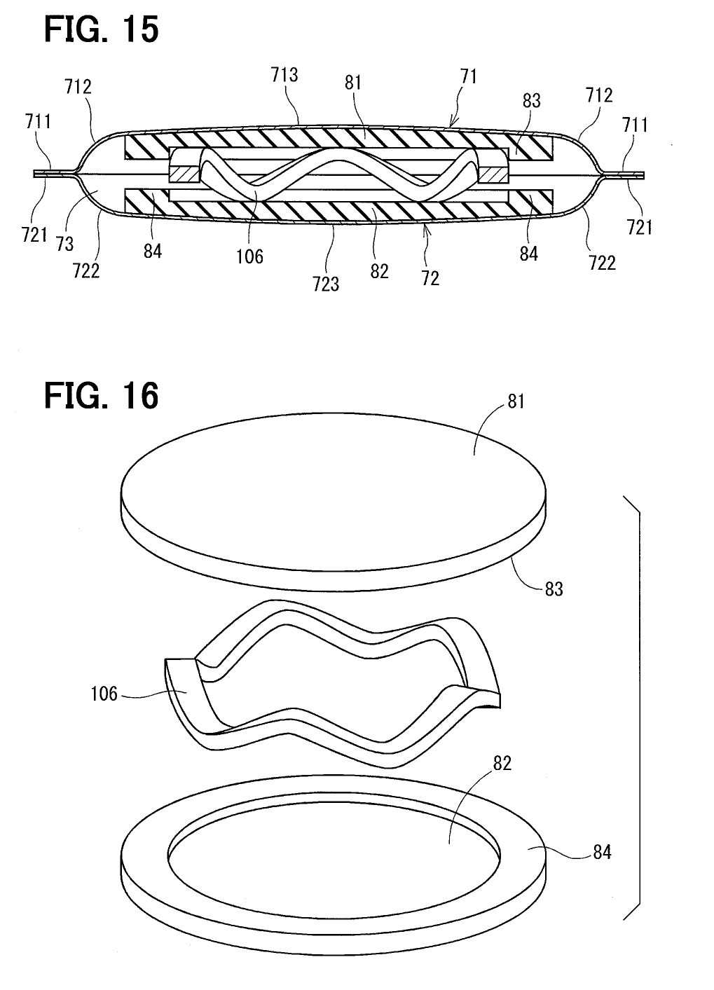

A seventh embodiment is illustrated in FIG. 15 and FIG. 16. In the seventh embodiment, a supporting member 106 is a wave spring. Accordingly, the wave spring as the supporting member 106 presses a first resilient member 81 against a first diaphragm 71, and presses a second resilient member 82 against a second diaphragm 72.

In the seventh embodiment, the same advantageous effects as the first to the sixth embodiments are achieved.

### Eighth Embodiment

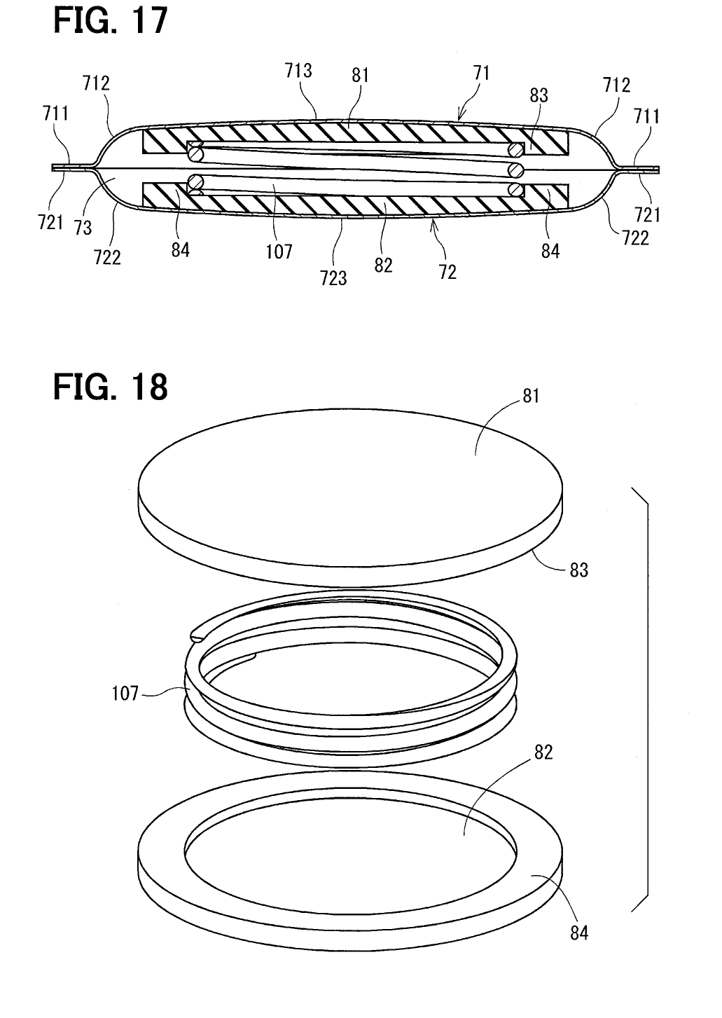

An eighth embodiment is illustrated in FIG. 17 and FIG. 18. In the eighth embodiment, a supporting member 107 is a compressed coil spring. Accordingly, the compressed coil spring as the supporting member 107 presses a first resilient member 81 against a first diaphragm 71, and presses a second resilient member 82 against a second diaphragm 72.

In the eighth embodiment, the same advantageous effects as the first to the seventh embodiments are achieved.

### Ninth Embodiment

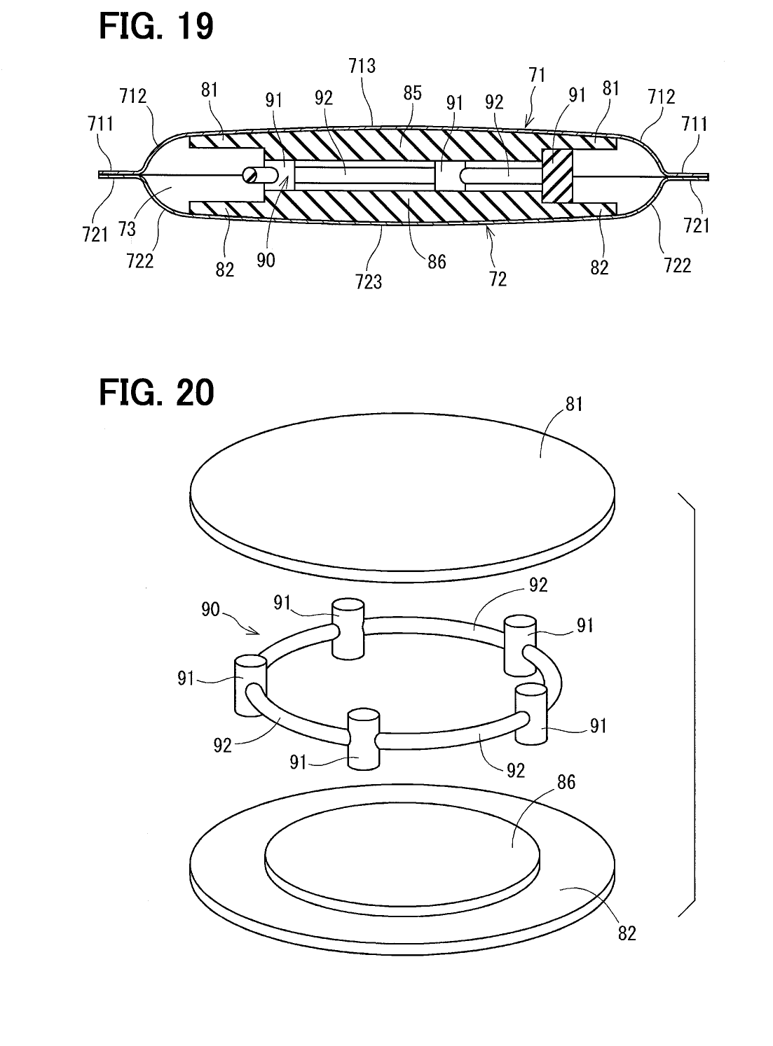

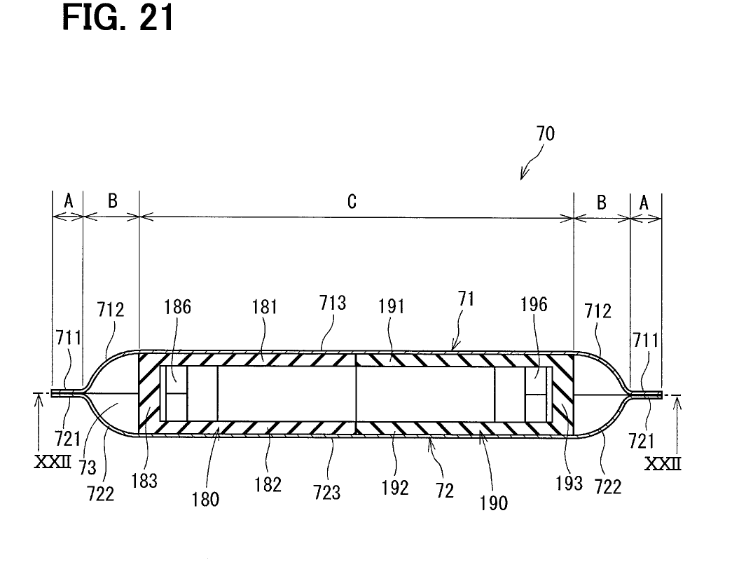

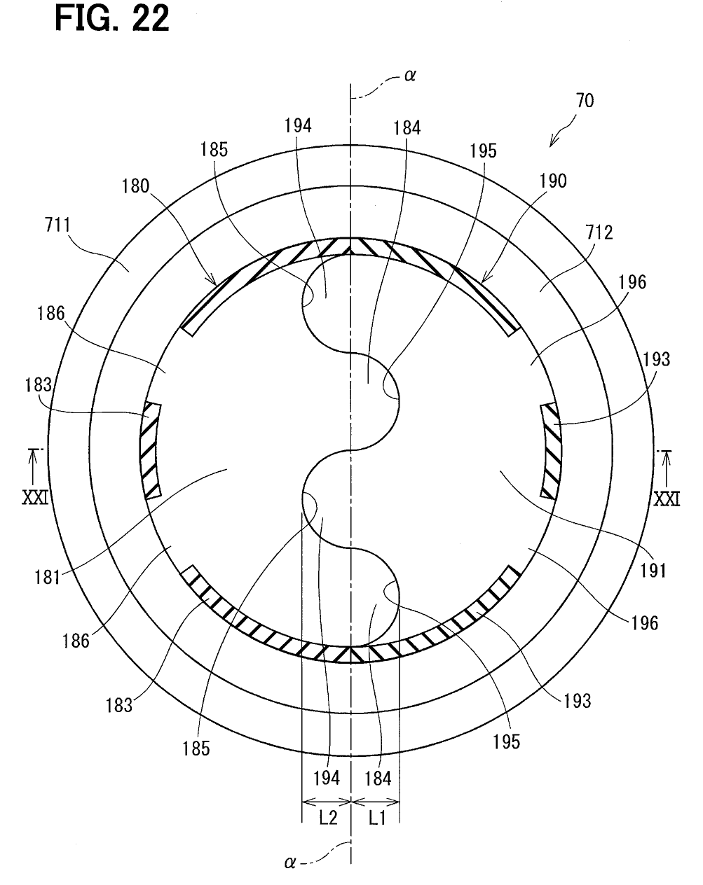

A ninth embodiment is illustrated in FIG. 19 and FIG. 20. In the ninth embodiment, a first projecting portion 85 of a first resilient member 81 and a second projecting portion 86 of a second resilient member 82 are both positioned radially inside of a supporting member 90. The first projecting portion 85 and the second projecting portion 86 prevent positional displacement in the radial direction of the supporting member 90.

In the ninth embodiment, the same advantageous effects as the first to the eighth embodiments are achieved and, in addition, the supporting member 90 is provided at a position radially outside of the first resilient member 81 and the second resilient member 82 in comparison with the configurations in the first to the eighth embodiments. Therefore, a pressure pulsation damping performance of a pulsation dumper 70 may be maintained.

In the above-described embodiments, a damper portion of the pulsation damper has a flat shape. In contrast, in other embodiments, the damper portion of the pulsation damper may have a corrugated shape.

In the embodiments described above, the first resilient member and the second resilient member are formed to have the same shape and of the same material. In contrast, in other embodiments, the first resilient member, the second resilient member, and the supporting member may be formed to have different shapes and of different materials. Accordingly, the resonance restraining performance and the pressure pulsation damping performance may be adjusted.

### Tenth Embodiment

As illustrated from FIG. 21 to FIG. 23, a first inscribed member 180 and a second inscribed member 190 have a column shape in contour by being assembled in a radial direction of a pulsation dumper 70 and are provided in a sealed space 73. The first inscribed member 180 and the second inscribed member 190 are formed, for example, of rubber, urethane, or elastomer.

The first inscribed member 180 includes a first resilient portion 181 a second resilient portion 182, and a first supporting portion 183.

The first resilient portion 181 is formed into a flat panel shape, and abuts against an inner wall of a first diaphragm 71. The second resilient portion 182 is formed into a flat panel shape, and abuts against an inner wall of a second diaphragm 72.

The first supporting portion 183 supports an outer peripheral portion of the first resilient portion 181 and an outer peripheral portion of the second resilient portion 182.

The second inscribed member 190 includes a third resilient portion 191, a fourth resilient portion 192, and a second supporting portion 193.

The third resilient portion 191 is formed into a flat panel shape, and abuts against the inner wall of the first diaphragm 71. The fourth resilient portion 192 is formed into a flat panel shape, and abuts against the inner wall of the second diaphragm 72.

The second supporting portion 193 supports an outer peripheral portion of the third resilient portion 191 and an outer peripheral portion of the fourth resilient portion 192.

“The outer peripheral portion of the first resilient portion 181”, “the outer peripheral portion of the second resilient portion 182”, “the outer peripheral portion of the third resilient portion 191”, and “the outer peripheral portion of the fourth resilient portion 192” indicate portions located on an outer periphery thereof when the first inscribed member 180 and the second inscribed member 190 are assembled into a column shape.

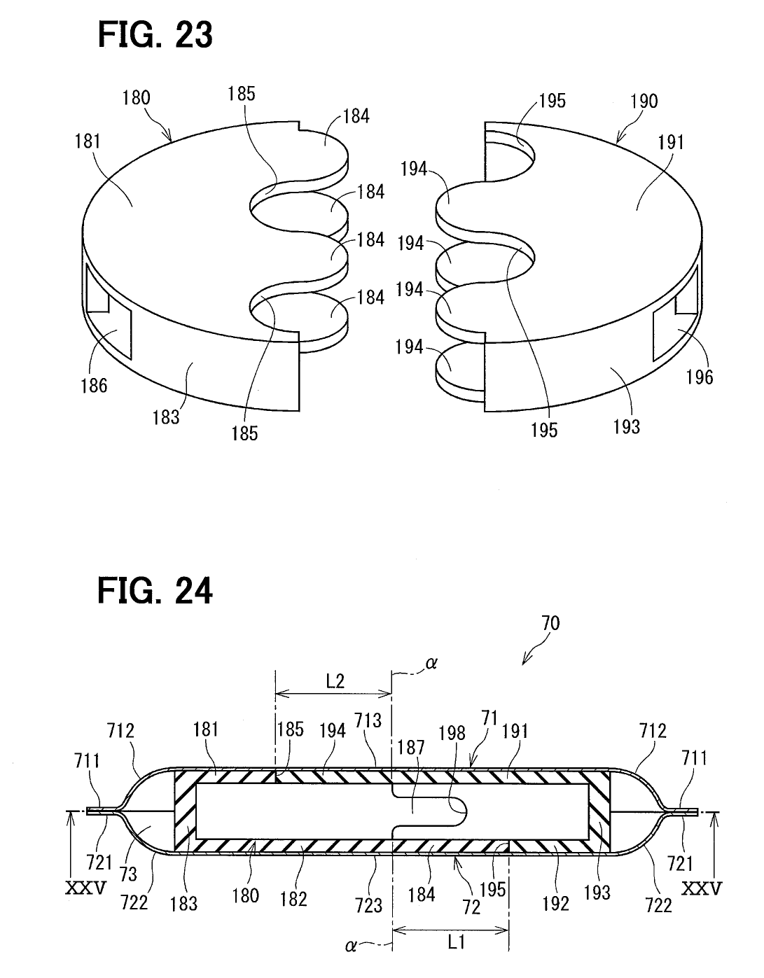

As illustrated in FIG. 22 and FIG. 23, the first resilient portion 181 and the second resilient portion 182 of the first inscribed member 180 include first projecting portions 184 extending toward the second inscribed member and first depressing portions 185 depressed away from the second inscribed member. The third resilient portion 191 and the fourth resilient portion 192 of the second inscribed member 190 include second projecting portions 194 extending toward the first inscribed member and second depressing portions 195 depressed in the direction away from the first inscribed member. The first projecting portions 184, the first depressing portions 185, the second projecting portions 194, and the second depressing portions 195 have a semicircular shape when viewed in the axial direction of the pulsation dumper 70.

The first projecting portions 184 of the first inscribed member 180 and the second depressing portions 195 of the second inscribed member 190 have compensated shapes, and both end surfaces thereof abut against each other when being assembled. The first depressing portions 185 of the first inscribed member 180 and the second projecting portions 194 of the second inscribed member 190 have a complementary shape, and both end surfaces thereof abut against each other when being assembled. Accordingly, positional displacement between the first inscribed member 180 and the second inscribed member 190 is prevented.

An imaginary plane a connecting one end surface and the other end surface of the first inscribed member 180 in the circumferential direction is illustrated in FIG. 22 by a chain line. A length that the first projecting portion 184 extends from the imaginary plane a to the second inscribed member is defined as L1, and a length that the first depressing portion 185 depresses from the imaginary plane a to the side opposite to the second inscribed member is defined as L2.

In FIG. 22, the imaginary plane a connects one end surface and the other end surface of the second inscribed member 190 as well in the circumferential direction. A length that the second projecting portion 194 extends from the imaginary plane a to the first inscribed member is defined as L2, and a length that the first depressing portion 185 depresses from the imaginary plane a to the side opposite to the first inscribed member is defined as L1.

The larger the values of L1 and L2, the lower the rigidities of the first projecting portions 184 of the first inscribed member 180 and the second projecting portions 194 of the second inscribed member 190 become. Therefore, by the setting of the values of L1 and L2, ease of bending of first to fourth resilient portions 181, 182, 191, and 192 may be adjusted.

The first supporting portion 183 and the second supporting portion 193 include passages 186 and 196 which extend in the radial direction. The passages 186 and 196 communicate a space radially inside the first supporting portion 183 and the second supporting portion 193 and a space radially outside the first supporting portion 183 and the second supporting portion 193 in the sealed space 73.

The larger an opening surface area of the passages 186 and 196, the lower the rigidities of the first supporting portion 183 and the second supporting portion 193 become. Therefore, by setting the opening surface areas of the passages 186 and 196, forces of the first supporting portion 183 and the second supporting portion 193 that presses the first to fourth resilient portions 181, 182, 191, and 192 against the diaphragms 71 and 72 may be adjusted.

With the provision of the passages 186 and 196 in the first supporting portion 183 and the second supporting portion 193, deformation of center portions of the two diaphragms 71 and 72 in the plate thickness direction is not impaired by an atmospheric pressure in the space radially inside the first supporting portion 183 and the second supporting portion 193. Therefore, the pulsation dumper 70 is capable of maintaining the pressure pulsation damping performance.

The first resilient portion 181 and the third resilient portion 191 abut against a substantially entire area from the vicinity of the connecting point between a first curved surface portion 712 and a first damper portion 713 to the first damper portion 713. The connecting point is a boundary between B and C illustrated in FIG. 21.

The first resilient portion 181 and the third resilient portion 191 need only to abut against a major area of the first damper portion 713 from the vicinity of the connecting point between the first curved surface portion 712 and the first damper portion 713. The expression “the vicinity of the connecting point” is an area larger or smaller than a diameter of the connecting point, and corresponds to a range in which lowering of a resonance restraining performance by the resilient portions 181 and 191 is allowed.

If an outer diameters of the first resilient portion 181 and the third resilient portion 191 are smaller than the diameter of the connecting point, even when the positions of the first resilient portion 181 and the third resilient portion 191 are displaced due to a tolerance at the time of assembly, such an event that the outer peripheral portion of the first resilient portion 181 or the third resilient portion 191 is pressed by the first curved surface portion 712 of the first diaphragm 71, and hence unintentional deformation of the first resilient member 81 is prevented from occurring.

However, if the outer diameters of the first resilient portion 181 and the third resilient portion 191 are smaller than the diameter of the connecting point, the resonance restraining performance is lowered. Therefore, the first resilient portion 181 and the third resilient portion 191 preferably abut against the first damper portion 713 over a range not smaller than 80% of the surface area thereof.

In contrast, if the shapes of an outer peripheral portions of end surfaces of the first resilient portion 181 and the third resilient portion 191 on the side of the first diaphragm match the shape of the first curved surface portion 712 of the first diaphragm 71, the outer diameters of the first resilient portion 181 and the third resilient portion 191 may be larger than the diameter of the connecting point.

In the first diaphragm 71, the radius of curvature of the first curved surface portion 712 and the radius of curvature of the first damper portion 713 are different. Therefore, the first resilient portion 181 and the third resilient portion 191 abut against the vicinity of the connecting point thereof, so that the first inscribed member 180 and the second inscribed member 190 are prevented from moving in the radial direction in the sealed space after the first inscribed member 180 and the second inscribed member 190 are mounted in the sealed space 73.

The second resilient portion 182 and the fourth resilient portion 192 abut against a substantially entire area from the vicinity of the connecting point between a second damper portion 723 and a second curved surface portion 722 to the second damper portion 723.

The configurations of the second resilient portion 182 and the fourth resilient portion 192 are substantially the same as the configurations of the first resilient portion 181 and the third resilient portion 191. Therefore, the description of the second resilient portion 182 and the fourth resilient portion 192 will be omitted.

The first supporting portion 183 presses the first resilient portion 181 against the first damper portion 713, and presses the second resilient portion 182 against the second damper portion 723. The second supporting portion 193 presses the third resilient portion 191 against the first damper portion 713, and presses the fourth resilient portion 192 against the second damper portion 723. Therefore, the first resilient portion 181 and the third resilient portion 191 are capable of restraining the resonance of the first diaphragm 71, and the second resilient portion 182 and the fourth resilient portion 192 are capable of restraining the resonance of the second diaphragm 72.

The first to fourth resilient portions 181, 182, 191, and 192 are not supported at positions located at the center of the pulsation dumper 70 by the first supporting portion 183 or the second supporting portion 193. Therefore, the center portion of the pulsation dumper 70 is easily deformable in the plate-thickness direction.

A high-pressure pump 1 in the tenth embodiment has the following advantageous effects.

(1) In the tenth embodiment, the first inscribed member 180 and the second inscribed member 190 assembled in the radial direction of the pulsation dumper 70 abut against the inner walls of the two diaphragms 71 and 72 in the sealed space. The first inscribed member 180 supports the outer peripheral portion of the first resilient portion 181 that abuts against the first diaphragm 71 and the outer peripheral portion of the second resilient portion 182 that abuts against the second diaphragm 72 by the first supporting portion 183. The second inscribed member 190 supports the outer peripheral portion of the third resilient portion 191 that abuts against the first diaphragm 71 and the outer peripheral portion of the fourth resilient portion 192 that abuts against the second diaphragm 72 by the second supporting portion 193.

By the abutment of the first to fourth resilient portions 181, 182, 191, and 192 against the two diaphragms 71 and 72, the resonance between the vibration transmitted from the internal combustion engine, the vibration transmitted from the electromagnetic drive unit 40 of the high-pressure pump 1, or the high-frequency pulsation of the fuel and the diaphragms 71 and 72 is restrained. Therefore, generation of the noise from the pulsation dumper 70 and the noise from a cover 60 of the high-pressure pump 1 may be restrained.

Since the outer peripheral portions of the first to fourth resilient portions 181, 182, 191, and 192 by first and second supporting portions 183 and 193, portions abutting against the center portions of the diaphragms 71 and 72 are liable to be bent. Since the first inscribed member 180 and the second inscribed member 190 are assembled in the radial direction of the pulsation dumper 70, portions abutting against the center portions of the diaphragms 71 and 72 are liable to be bent. Therefore, the pulsation dumper 70 is capable of maintaining the pressure pulsation damping performance without impairing deformation of the center portions of the diaphragms 71 and 72.

In addition, since the first to fourth resilient portions 181, 182, 191, and 192 are supported by the first and second supporting portions 183 and 193, and are not adhered to the diaphragms 71 and 72 with the adhesive agent, deterioration with time may be prevented.

(2) In the tenth embodiment, the first projecting portions 184 of the first inscribed member 180 and the second depressing portions 195 of the second inscribed member 190 are assembled, and the first depressing portions 185 of the first inscribed member 180 and the second projecting portions 194 of the second inscribed member 190 are assembled.

Accordingly, the positional displacement between the first inscribed member 180 and the second inscribed member 190 is prevented.

By setting the length L1 of the first projecting portions 184 extending from the imaginary plane a toward the second inscribed member and the length L2 of the second projecting portions 194 extending from the imaginary plane a toward the first inscribed member, ease of bending of the center portions of the first to fourth resilient portions 181, 182, 191, and 192 may be adjusted.

(3) In the tenth embodiment, the first resilient portion 181 and the third resilient portion 191 abut against the substantially entire area from the vicinity of the connecting point between the first damper portion 713 and the first curved surface portion 712 to the first damper portion 713. The second resilient portion 182 and the fourth resilient portion 192 abut against a substantially entire area from the vicinity of the connecting point between the second damper portion 723 and the second curved surface portion 722 to the second damper portion 723.

Accordingly, since the first to fourth resilient portions 181, 182, 191, and 192 abut against major range of the movable areas of the two diaphragms 71 and 72, the resonance between the diaphragms 71 and 72 is reliably restrained.

(4) In the tenth embodiment, the first supporting portion 183 and the second supporting portion 193 include passages 186 and 196 which extend in the radial direction.

By setting the opening surface areas of the passages 186 and 196, rigidity of the first supporting portion 183 and the second supporting portion 193 are adjusted and a force that presses the first to fourth resilient portions 181, 182, 191, and 192 against the diaphragms 71 and 72 may be adjusted.

Deformation of center portions of the two diaphragms 71 and 72 in the plate thickness direction is not impaired by an atmospheric pressure in the space radially inside the first supporting portion 183 and the second supporting portion 193, so that the pulsation dumper 70 can maintain the pressure pulsation damping performance.

(5) In the tenth embodiment, the first inscribed member 180 and the second inscribed member 190 have the same shape.

Accordingly, the number of types of the components may be reduced, and the manufacturing cost may be reduced.

### Eleventh Embodiment

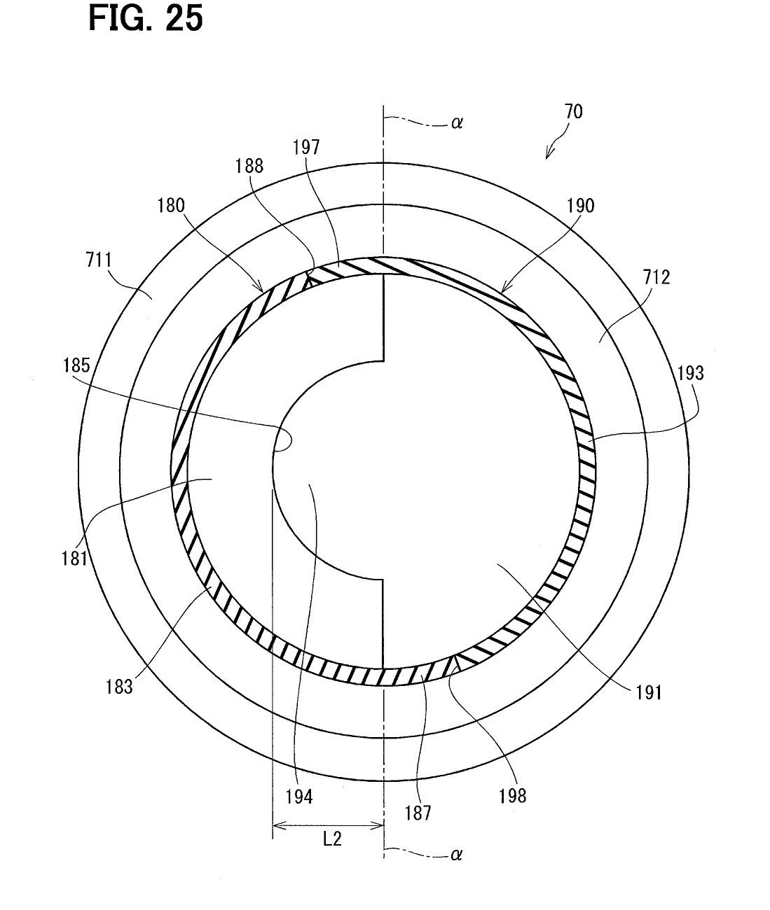

An eleventh embodiment of this disclosure is illustrated in FIG. 24 to FIG. 26. Hereinafter, in a plurality of embodiments, substantially the same configurations as the tenth embodiment described above are denoted by the same reference signs, and the description will be omitted.

In the eleventh embodiment, a first inscribed member 180 includes one first depressing portion 185 on a first resilient portion 181, and one first projecting portion 184 on a second resilient portion 182. A second inscribed member 190 includes one second projecting portions 194 in a third resilient portion 191 and one second depressing portions 195 in a fourth resilient portion 192. The first depressing portions 185 and the second projecting portions 194 have a complementary shape, and the first projecting portions 184 and the second depressing portions 195 have a complementary shape.

The first projecting portions 184 and the second projecting portions 194 have a semicircular shape when viewed in the axial direction of the pulsation dumper 70, and the center of the circle substantially match a center of the pulsation dumper 70.

A length that the first projecting portion 184 extends from the imaginary plane a to a second inscribed member is defined as L1, and a length that the second projecting portion 194 extends from the imaginary plane a toward the first inscribed member is defined as L2. The larger the values of L1 and L2, the lower the rigidities of the first projecting portions 184 of the first inscribed member 180 and the second projecting portions 194 of the second inscribed member 190 become. Therefore, by the setting of the values of L1 and L2, ease of bending of first to fourth resilient portions 181, 182, 191, and 192 may be adjusted.

The first inscribed member 180 includes a third projecting portion 187 projecting toward the second inscribed member on a first supporting portion 183 and a third depressing portion 188 depressing in the direction away from the second inscribed member. The second inscribed member 190 includes a fourth projecting portion 197 projecting toward the first inscribed member on a second supporting portion 193 and a fourth depressing portion 198 depressing in the direction away from the first inscribed member. The third projecting portion 187 and the fourth depressing portion 198 have a complementary shape and are assembled to each other. The third depressing portion 188 and the fourth projecting portion 197 have a complementary shape and are assembled to each other. Accordingly, the positional displacement between the first inscribed member 180 and the second inscribed member 190 in the axial direction is prevented.

The first inscribed member 180 and the second inscribed member 190 can be assembled into a sealed space of the pulsation dumper 70 easily by being integrated with each other.

In the eleventh embodiment, the same advantageous effects as the tenth embodiment are achieved.

### Twelfth Embodiment

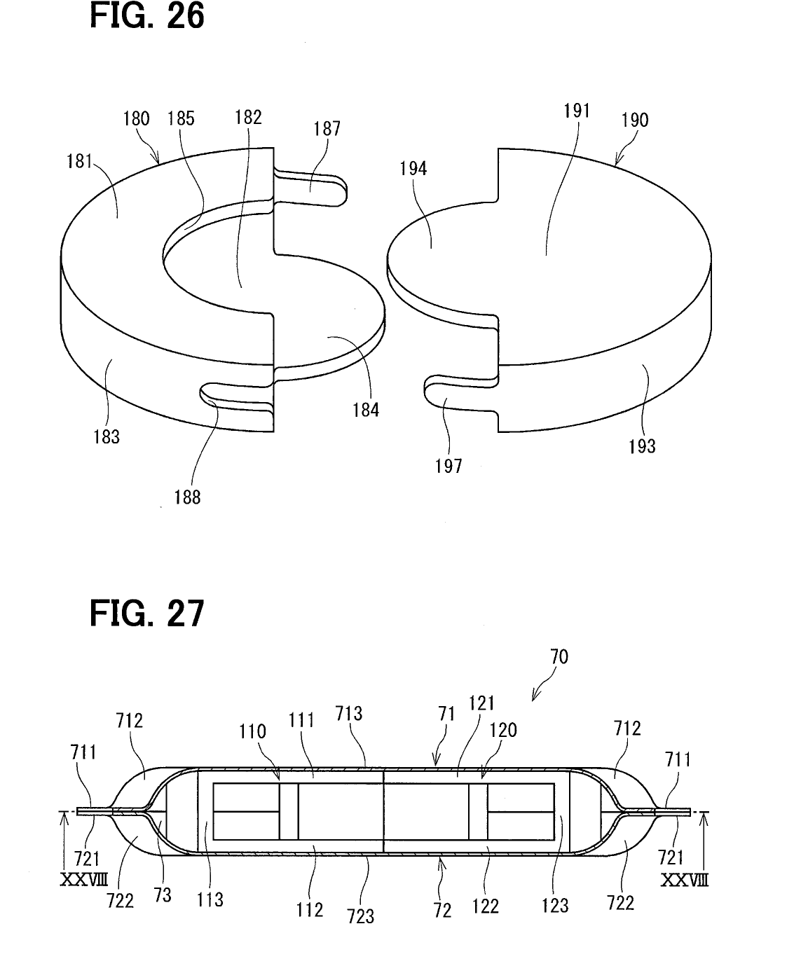

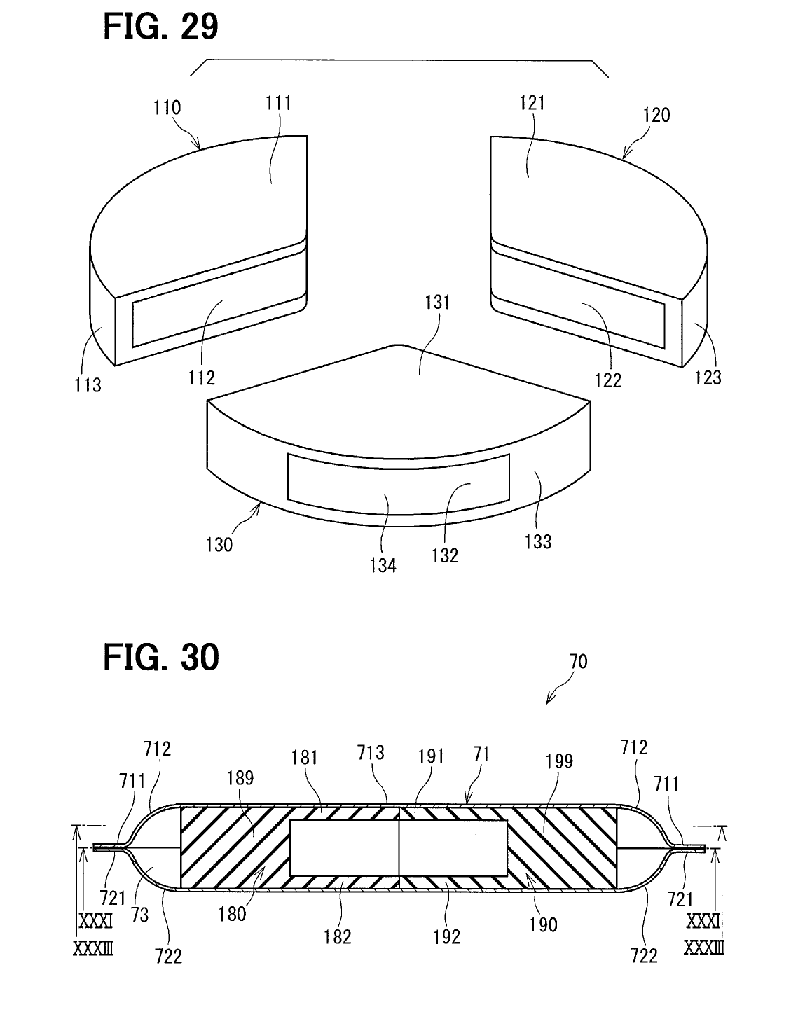

A twelfth embodiment of this disclosure is illustrated in FIG. 27 to FIG. 29. In the twelfth embodiment, a pulsation dumper 70 includes a first inscribed member 110, a second inscribed member 120, and a third inscribed member 130.

The first to third inscribed members 110, 120, and 130 each have fan shapes when viewed in the axial direction of the pulsation dumper 70. The first to third inscribed members 110, 120, and 130 each are assembled so that end surfaces in the circumferential direction abut against each other with a center of the pulsation dumper 70 as a boundary, and are provided in a sealed space 73.

The first inscribed member 110 includes a first resilient member 111, a second resilient member 112, and a first supporting portion 113. The second inscribed member 120 includes a third resilient portion 121, a fourth resilient portion 122, and a second supporting portion 123. The third inscribed member 130 includes a fifth resilient portion 131, a sixth resilient portion 132, and a third resilient portion 133.

The first resilient member 111, the third resilient portion 121, and the fifth resilient portion 131 abut against an inner wall of a first diaphragm 71. The second resilient member 112, the fourth resilient portion 122, and the sixth resilient portion 132 abut against an inner wall of a second diaphragm 72.

The first to third inscribed members 110, 120, and 130 include passages 114, 124, and 134 which extend in the radial direction.

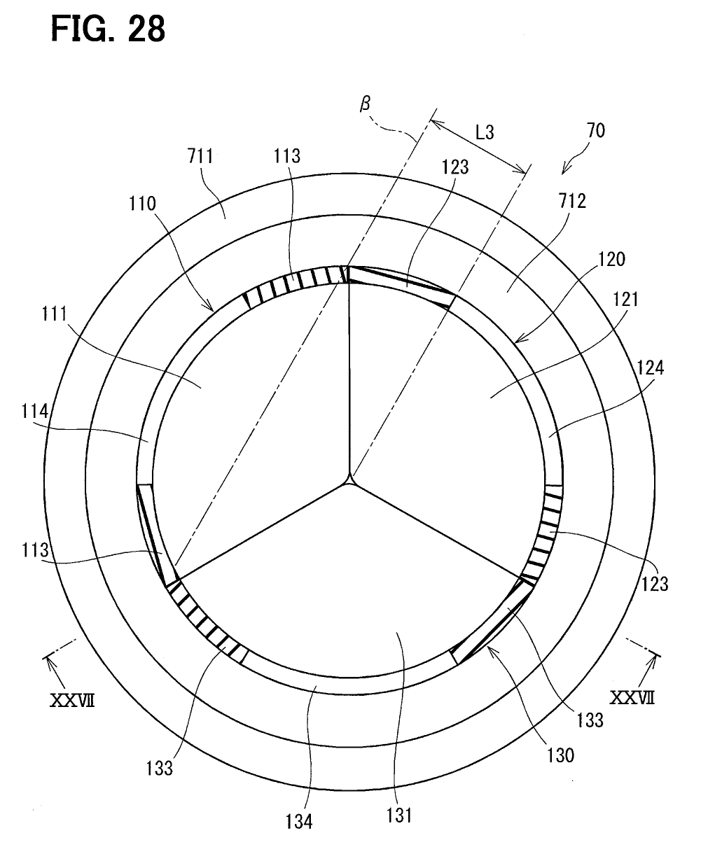

In the twelfth embodiment, the first to third inscribed members 110, 120, and 130 are combined with each other with the center of the pulsation dumper 70 as a boundary. Therefore, as illustrated in FIG. 28, in the first inscribed member 110, a perpendicular length L3 from an imaginary plane β which connects one end surface and the other end surface of the first supporting portion 113 in the circumferential direction to a position of the first resilient member 111, corresponding to the center of the pulsation dumper 70 is increased. The same applies to the second inscribed member 120 and the third inscribed member 130. Therefore, the first to third inscribed members 110, 120, 130 are easily bent at positions abutting against the center portions of the diaphragms 71 and 72. Therefore, the pulsation dumper 70 is capable of maintaining a pressure pulsation damping performance without impairing actions of the diaphragms 71 and 72 by the first to third inscribed members 110, 120, and 130.

### Thirteenth Embodiment

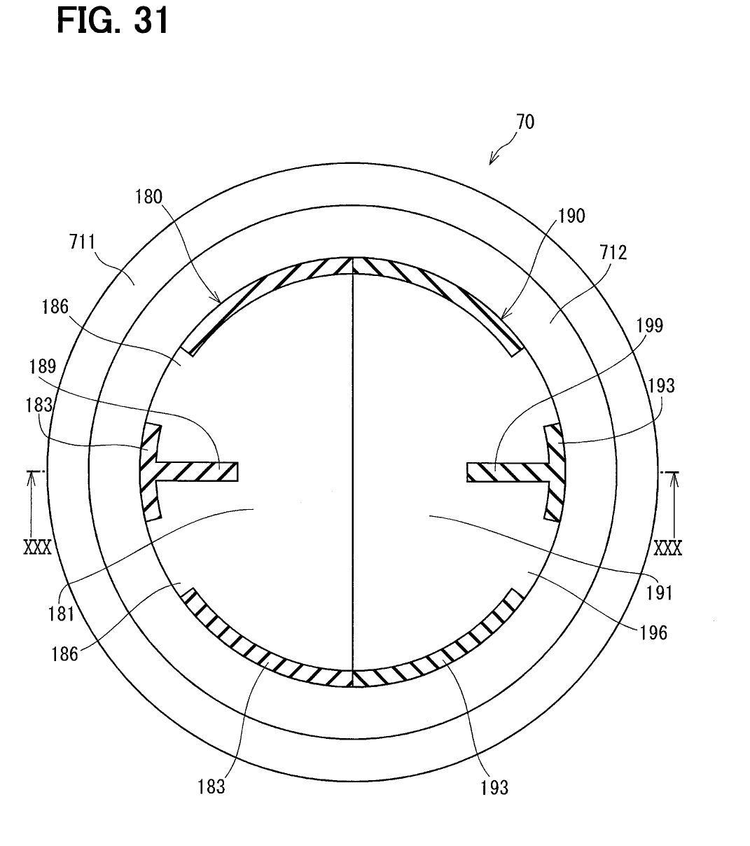

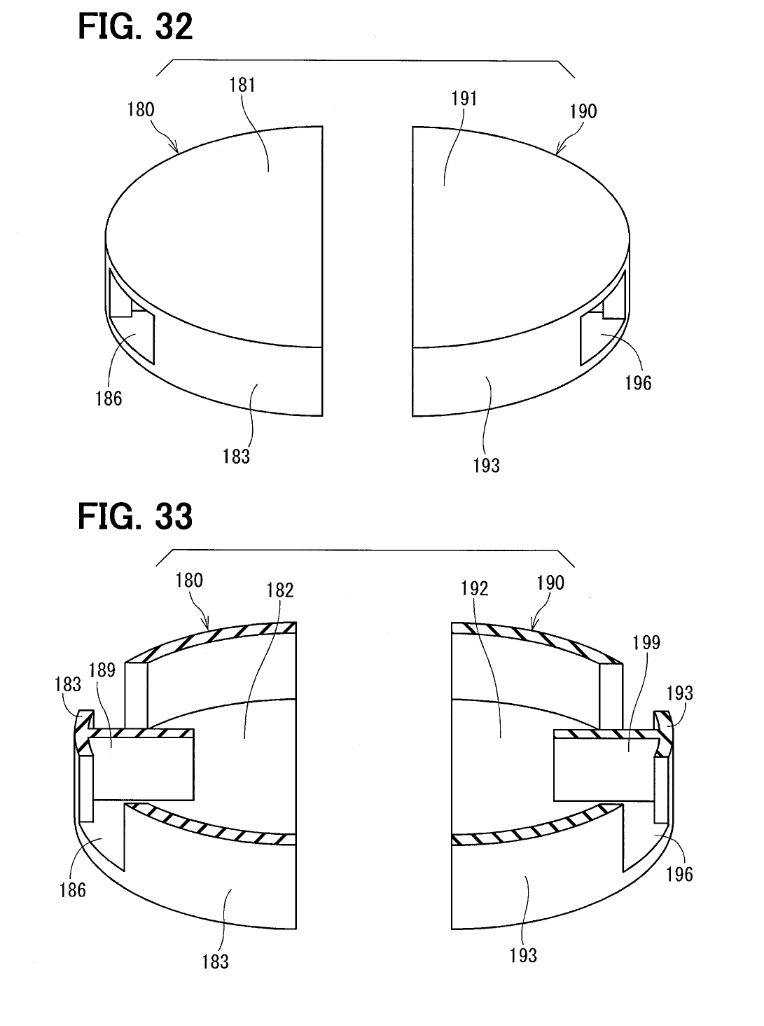

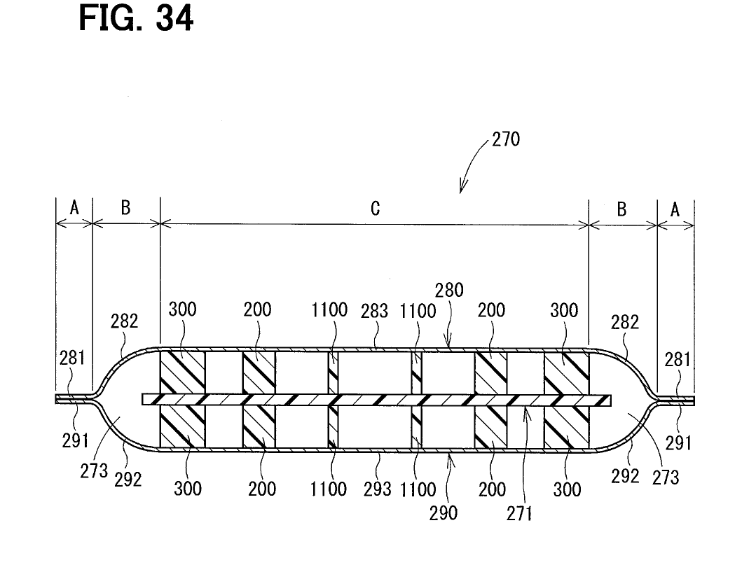

A thirteenth embodiment of this disclosure is illustrated in FIG. 30 to FIG. 33. In the thirteenth embodiment, a first inscribed member 180 does not have a first projecting portion 184 and a first depressing portion 185. A second inscribed member 190 does not have a second projecting portion 194 and a second depressing portion 195.

Instead, the first inscribed member 180 includes a first rib 189 extending radially inward from a first supporting portion 183, and supporting a first resilient portion 181 and a second resilient portion 182. The second inscribed member 190 includes a second rib 199 extending radially inward from a second supporting portion 193 and supporting a third resilient portion 191 and a fourth resilient portion 192.

In the thirteenth embodiment, rigidities of the first resilient portion 181 and the second resilient portion 182 can be adjusted by setting the length, width, or number of the first ribs 189. Rigidities of the third resilient portion 191 and the fourth resilient portion 192 can be adjusted by setting the length, width, or number of the second ribs 199. Therefore, the pulsation dumper 70 is capable of both maintaining the pulsation damping performance and restraining a resonance.

In the above-described embodiments, a damper portion of the pulsation damper has a flat shape. The damper portion of the pulsation damper may have a corrugated shape.

In the embodiments described above, the first inscribed member and the second inscribed member are formed to have the same shape and of the same material. The first inscribed member and the second inscribed member may be formed to have different shapes and of different materials.

In the tenth, twelfth, and thirteenth embodiments described above, all of the inscribed members have a passage. One of the inscribed members may have one passage, or the passage may be eliminated.

In the tenth, eleventh, and thirteenth embodiments described above, two inscribed members are assembled. In the twelfth embodiment, three inscribed members are combined. Four or more inscribed members may be combined in the radial direction and/or circumferential direction of the pulsation damper.

### Fourteenth Embodiment

As illustrated in FIG. 34, a pulsation dumper 70 includes a first diaphragm 280, a second diaphragm 290, and a resonance restraining device 271.

The first diaphragm 280 and the second diaphragm 290 are formed into a dish shape by pressing a metallic plate having a high-yield strength and a high-fatigue limit such as stainless steel.

The first diaphragm 280 integrally includes a first outer edge portion 281, a first curved surface portion 282, and a first damper portion 283. In FIG. 34, ranges of the first outer edge portion 281, the first curved surface portion 282, and the first damper portion 283 are shown by A, B, and C.

The first outer edge portion 281 is formed into a ring shape. The first curved surface portion 282 extends from the first outer edge portion 281 toward the second diaphragm 290, and is bent radially inward.

The first damper portion 283 is provided radially inside the first curved surface portion 282. The first damper portion 283 is larger in radius of curvature than the first curved surface portion 282, and is formed into a substantially flat shape.

The second diaphragm 290 integrally includes a second outer edge portion 291, a second curved surface portion 292, and a second damper portion 293. The configuration of the second diaphragm 290 is substantially the same as the configuration of the first diaphragm 280, so that the description is omitted.

The first damper portion 283 and the second damper portion 293 are not limited to have a flat shape, and may be, for example, a corrugated shape.

The first diaphragm 280 and the second diaphragm 290 may have different shapes.

The pulsation dumper 70 has a configuration in which the first outer edge portion 281 of the first diaphragm 280 and the second outer edge portion 291 of the second diaphragm 290 are joined and gas having a predetermined pressure is sealed in a sealed space 273 inside thereof. The pulsation dumper 70 is configured to reduce the fuel pressure pulsation of a fuel chamber 61 by resiliently deforming center portions of two diaphragms 280 and 290 in a plate-thickness direction about center portions thereof, according to change of the fuel pressure in the fuel chamber 61.

The plate thickness, the material, the outer diameter, and the atmospheric pressure encapsulated in the sealed space 273 of the two diaphragms 280 and 290 are set as needed in accordance with durability or other required performances, so that a spring constant of the pulsation dumper 70 is determined. In addition, a frequency of the fuel pressure pulsation and a pulsation damping performance that the pulsation dumper 70 can reduce is determined on the basis of the spring constant.

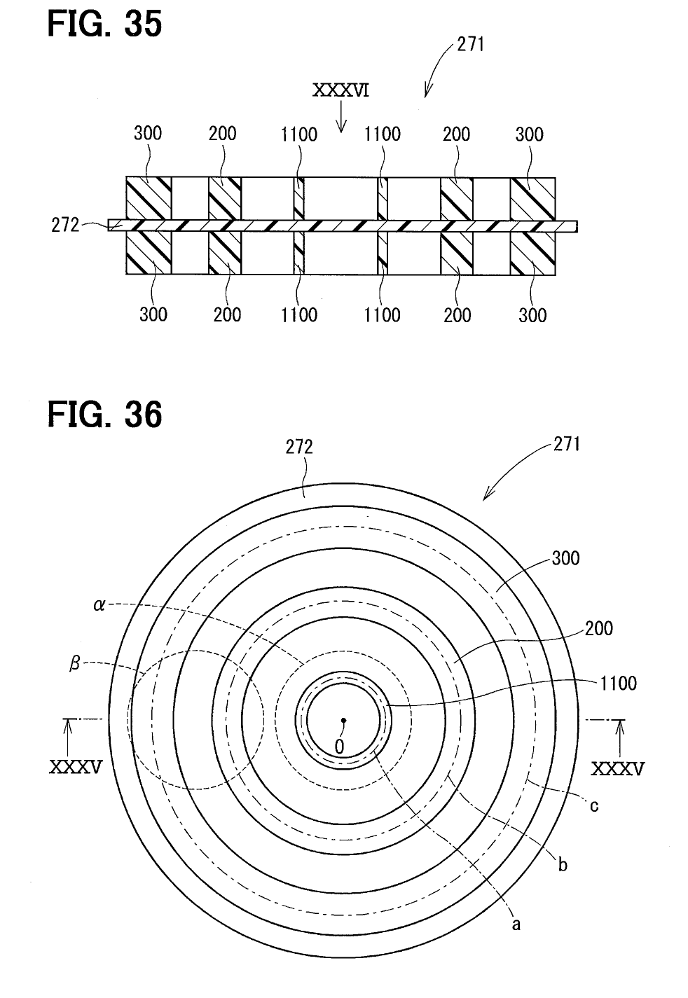

As illustrated in FIG. 34 to FIG. 36, the resonance restraining device 271 includes a disc-shaped base plate 272, and a plurality of resilient ribs 100, 200, and 300 extending from the base plate 272, and is provided in the sealed space 273 of the pulsation dumper 70. The base plate 272 and a plurality of resilient ribs 100, 200, and 300 are integrally formed of a resilient member such as rubber, urethane, and elastomer. A configuration in which the base plate 272 is formed of a resin or a metal, and a plurality of the resilient ribs 100, 200, and 300 are formed of a resilient member, and the base plate 272 and a plurality of the resilient ribs 100, 200, and 300 are bonded or welded is also applicable.

A plurality of the resilient ribs 100, 200, and 300 include an upper resilient rib that presses an inner wall of the first diaphragm 280, and a lower resilient rib that presses an inner wall of the second diaphragm 290. In this specification and the drawings, the upper resilient rib and the lower resilient rib are denoted by the same reference numeral and these ribs are described as having the same configuration. However, the upper resilient rib and the lower resilient rib may have different configuration by combining the configurations described in the first to the seventeenth embodiments.

A plurality of resilient ribs 100, 200, and 300 include a first resilient rib 100, a is second resilient rib 200, and a third resilient rib 300 provided concentrically. The first to third resilient ribs 100, 200, and 300 is provided continuously in the circumference direction of the pulsation dumper 70.

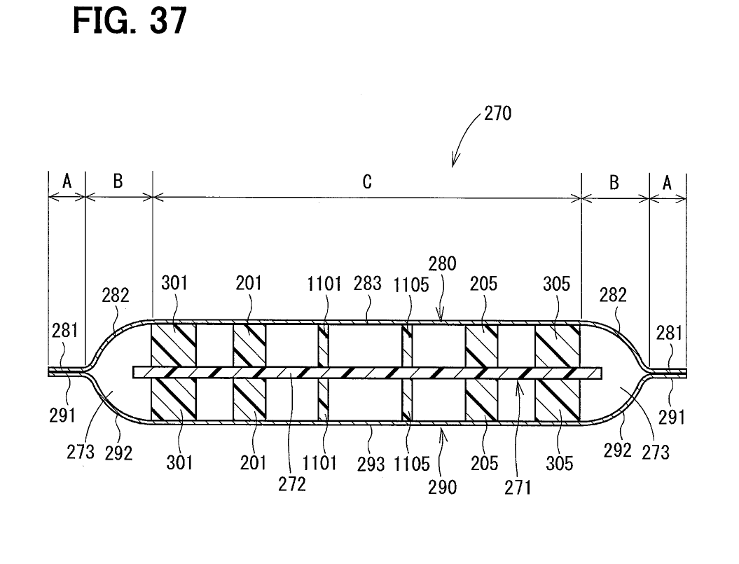

The first resilient rib 100 is provided at a position surrounding a center position O of the pulsation dumper 70 except for the center position O. In FIG. 36, a reference sign O is marked at a position where the center position O of the pulsation dumper 70 is projected on the base plate 272 of the resonance restraining device 271.

The third resilient rib 300 is provided on the radially inside the first curved surface portion 282 and the second curved surface portion 292 of the pulsation dumper 70, and is provided at a position which allows pressing of the first damper portion 283 and the second damper portion 293.

The second resilient rib 200 is provided between the first resilient rib 100 and the third resilient rib 300.

In the embodiment, the first to third resilient ribs 100, 200, and 300 are provided so that the intervals of center positions a, b, and c of the plate thickness in the radial direction are arranged at regular pitches.

The thickness of the first resilient rib 100 is smaller than the thickness of the second resilient rib 200, and the thickness of the second resilient rib 200 is thinner than the thickness of the third resilient rib 300. Accordingly, the resilient rib provided in a predetermined range α of a center portion of the pulsation dumper 70 is configured to be bent more easily than the resilient rib having the same surface area and being provided in a predetermined range β radially outside the pulsation dumper 70. The predetermined ranges α and β described above are not limited to the shape and surface area illustrated in FIG. 36, and may be set arbitrarily.

Ease of bending may be adjusted by setting the thicknesses of the first to third resilient ribs 100, 200, and 300. Accordingly, a force of pressing the first to third resilient ribs 100, 200, and 300 against the diaphragms 280 and 290 can be adjusted. The resonance restraining device 271 is capable of restraining a resonance of the diaphragms 280 and 290 by pressing the first to third resilient ribs 100, 200, and 300 against the first damper portion 283 and the second damper portion 293.

The resilient rib provided in a predetermined range a of a center portion of the pulsation dumper 70 is bent more easily than the resilient rib provided in a predetermined range β, which is radially outside. Therefore, deformation of the center portion of the pulsation dumper 70 in the plate thickness direction is not impaired by the resilient rib, so that deformation is easily achieved. Therefore, the resonance restraining device 271 is capable of maintaining a pressure pulsation damping performance of the pulsation dumper 70.

An outer diameter of the third resilient rib 300 is substantially the same as an outer diameter of the first damper portion 283. The outer diameter of the first damper portion 283 indicates a boundary between B and C illustrated in FIG. 34.

In the first diaphragm 280, a radius of curvature of the first damper portion 283 and a radius of curvature of the first curved surface portion 282 are different. Therefore, the resonance restraining device 271 is prevented from moving in the radial direction in the sealed space by the third resilient rib 300 pressing a position in the vicinity of a connecting point between the first damper portion 283 and the first curved surface portion 282.

If an outer diameters of the third resilient rib 300 is smaller than the diameter of the first damper portion 283, even when the position of the resonance restraining device 271 is displaced due to a tolerance at the time of assembly, such an event that the outer peripheral portion of the third resilient rib 300 is pressed by the first curved surface portion 282 of the first diaphragm 280, and hence occurrence of unintentional deformation is prevented.

In contrast, if the shape of an outer peripheral portion of the third resilient rib 300 matches the shape of the first curved surface portion 282, the outer diameter of the third resilient rib 300 may be larger than the diameter of the first damper portion 283.

A high-pressure pump 1 in the fourteenth embodiment has the following advantageous effects.

(1) In the fourteenth embodiment, the resonance restraining device 271 provided in the sealed space 273 of the pulsation dumper 70 integrally includes the base plate 272 and a plurality of the resilient ribs 100, 200, and 300 extending from the base plate 272 and pressing the inner walls of the two diaphragms 280 and 290.

By a plurality of resilient ribs 100, 200, and 300 pressing the inner walls of the diaphragms 280 and 290, the resonance between the vibration transmitted from the internal combustion engine, the vibration transmitted from the electromagnetic valve, or the high-frequency pulsation of the fuel and the two diaphragms 280 and 290 is restrained. Therefore, generation of the noise from the pulsation dumper 70 and the noise from a cover 60 of the high-pressure pump 1 may be restrained.

In addition, assembly of the resonance restraining device 271 into the sealed space is easy because a plurality of resilient ribs 100, 200, and 300 are integrally connected by the base plate 272. Also, since the resonance restraining device 271 is not adhered to the diaphragms 280 and 290 with the adhesive agent, separation or the like due to deterioration with time is prevented.

The resonance restraining device 271 may be assembled either in upward orientation or downward orientation in the sealed space.

(2) In the fourteenth embodiment, the resilient rib provided in a predetermined range α of a center portion of the pulsation dumper 70 is configured to be bent more easily than the resilient rib having the same surface area and being provided in a predetermined range β radially outside the pulsation dumper 70.

Accordingly, the pulsation dumper 70 is capable of maintaining the pressure pulsation damping performance without impairing deformation of the center portions of the diaphragms 280 and 290. Therefore, with the pulsation dumper 70, a pressure pulsation of the fuel chamber 61 and a pressure pulsation of fuel in a fuel supply system including fuel piping, which is not illustrated, communicating thereto may be reduced.

(3) In the fourteenth embodiment, a surface area of the resilient rib provided in the predetermined range α abutting against the first diaphragm 280 and the second diaphragm 290 is smaller than a surface area of the resilient rib provided in the predetermined range β abutting against the first diaphragm 280 and the second diaphragm 290.

Accordingly, the resilient rib provided in the predetermined range a may be configured to be capable of being bent more easily than the resilient rib provided in the predetermined range β.

(4) In the fourteenth embodiment, a plurality of the resilient ribs 100, 200, and 300 are provided radially inside the first curved surface portion 282 and the second curved surface portion 292, and press the inner wall of the first damper portion 283 and the inner wall of the second damper portion 293.

Accordingly, the resonance generating in the first damper portion 283 and the second damper portion 293 is reliably restrained.

(5) In the fourteenth embodiment, the thickness of the resilient rib provided in the predetermined range α is thinner than the thickness of the resilient rib provided in the predetermined range β.

Accordingly, the resilient rib provided in a predetermined range α at a center portion of the pulsation dumper 70 may be configured to be bent more easily than the resilient rib having the same surface area and provided in a predetermined range β which is radially outside the pulsation dumper 70.

(6) In the fourteenth embodiment, a plurality of resilient ribs 100, 200, and 300 is provided continuously in the circumferential direction of the pulsation dumper 70.

Accordingly, the surface area that the resilient ribs 100, 200, and 300 abut against the pulsation dumper 70 may be increased. The rigidity of the resilient ribs 100, 200, and 300 may be increased.

(7) In the fourteenth embodiment, a plurality of resilient ribs 100, 200, and 300 is provided at a position on the pulsation dumper 70 except for the center position O.

Accordingly, the pulsation dumper 70 is capable of maintaining the pressure pulsation damping performance without impairing deformation of the center portions of the diaphragms 280 and 290 by the resilient rib 100.

### Fifteenth Embodiment

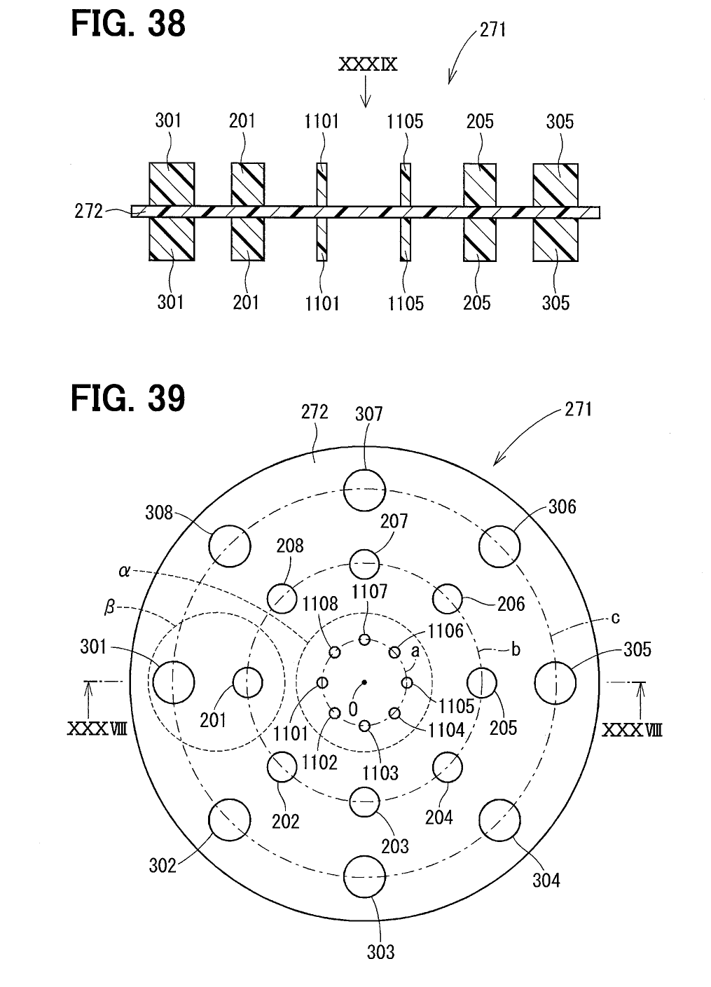

A fifteenth embodiment is illustrated in FIG. 37 to FIG. 39. Hereinafter, in a plurality of embodiments, substantially the same configurations as the fourteenth embodiment described above are denoted by the same reference signs, and the description will be omitted.

In the fifteenth embodiment, a resonance restraining device 271 includes first to third resilient ribs extending from a base plate 272 intermittently in a circumferential direction of a pulsation damper.

First resilient ribs 101 to 108 include, for example, eight resilient ribs.

Second resilient ribs 201 to 208 include, for example, eight resilient ribs.

Third resilient ribs 301 to 308 include, for example, eight resilient ribs.

The first to third resilient ribs 101 to 108, 201 to 208, and 301 to 308 are not limited to a column shape, but may be a square pole or a fan-shaped pole.

An assembly of the first resilient ribs 101 to 108, an assembly of the second resilient ribs 201 to 208 and an assembly of the third resilient ribs 301 to 308 are concentrically arranged. In other words, an imaginary line “a” that connects centers of the first resilient ribs 101 to 108, an imaginary line “b” that connects centers of the second resilient ribs 201 to 208, and an imaginary line “c” that connects centers of the third resilient ribs 301 to 308 are concentrically arranged.

The first resilient ribs 101 to 108 are thinner than the second resilient ribs 201 to 208, and the second resilient ribs 201 to 208 are thinner than the third resilient ribs 301 to 308. In other words, the thickness of the first resilient ribs 101 to 108 is smaller than the thickness of the second resilient ribs 201 to 208, and the thickness of the second resilient ribs 201 to 208 is smaller than the thickness of the third resilient ribs 301 to 308.

Accordingly, the assembly of the resilient ribs provided in a predetermined range a of a center portion of the pulsation dumper 70 is configured to be bent more easily than the assembly of the resilient ribs having the same surface area and being provided in a predetermined range β radially outside the pulsation dumper 70. Therefore, deformation of the center portion of the pulsation dumper 70 in the plate thickness direction is not impaired by the resilient ribs 101 to 108, 201 to 208, and 301 to 308, so that deformation is easily achieved. Therefore, the resonance restraining device 271 is capable of maintaining a pressure pulsation damping performance of the pulsation dumper 70.

By setting the thicknesses of the first to third resilient ribs 101 to 108, 201 to 208, and 301 to 308, ease of bending of the same may be adjusted, and a force of pressing the same against the diaphragms 280 and 290 may be adjusted. The first to third resilient ribs 101 to 108, 201 to 208, and 301 to 308 are capable of restraining a resonance of the diaphragms 280 and 290 by pressing a first damper portion 283 and a second damper portion 293.

In the fifteenth embodiment, in addition to the advantageous effect of the above-described fourteenth embodiment, the following advantageous effects will be achieved.

(1) In the fifteenth embodiment, the assembly of the resilient ribs provided in a predetermined range α of a center portion of the pulsation dumper 70 is configured to be bent more easily than the assembly of the resilient ribs having the same surface area and being provided in a predetermined range β radially outside the pulsation dumper 70.

Accordingly, the pulsation dumper 70 is capable of maintaining the pressure pulsation damping performance without impairing deformation of the center portions of the diaphragms 280 and 290.

(2) In the fifteenth embodiment, a surface area of the assembly of the resilient ribs provided in the predetermined range α abutting against the first diaphragm 280 and the second diaphragm 290 is smaller than a surface area of the assembly of the resilient ribs provided in the predetermined range β abutting against the first diaphragm 280 and the second diaphragm 290.

Accordingly, the assembly of the resilient ribs provided in the predetermined range α may be configured to be capable of being bent more easily than the assembly of the resilient rib provided in the predetermined range β.

(3) In the fifteenth embodiment, the first to third resilient ribs 101 to 108, 201 to 208, and 301 to 308 are provided intermittently in the circumferential direction of the pulsation dumper 70.

Accordingly, the amount of the resilient member to be used for forming the resonance restraining device 271 may be reduced, and hence the manufacturing cost may be reduced.

### Sixteenth Embodiment

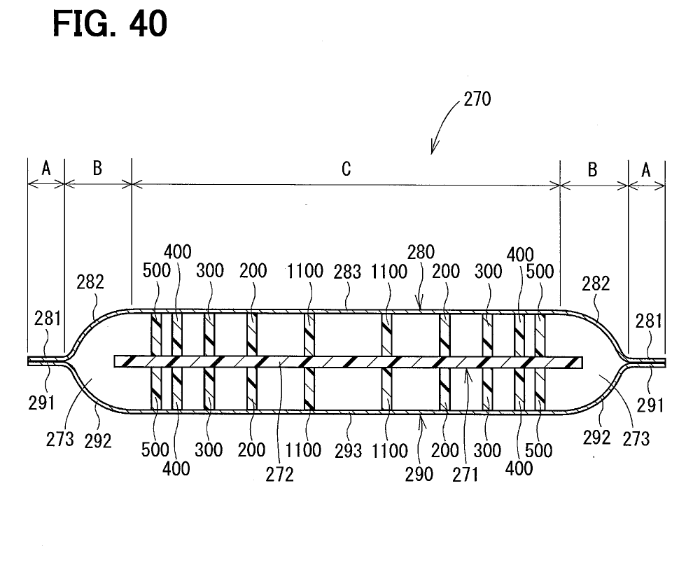

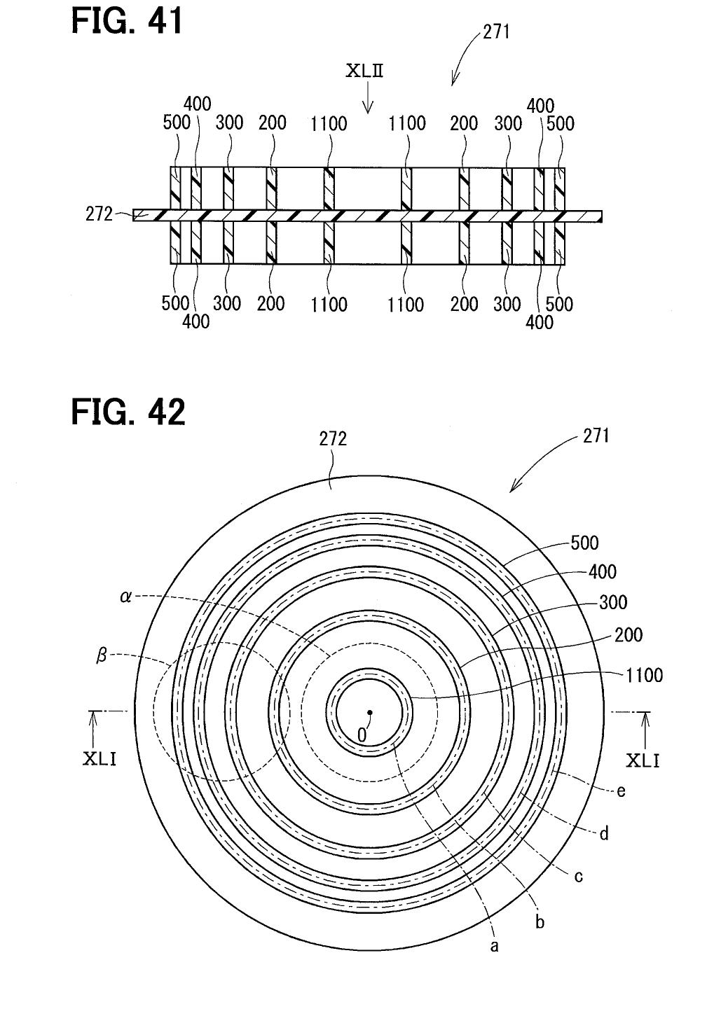

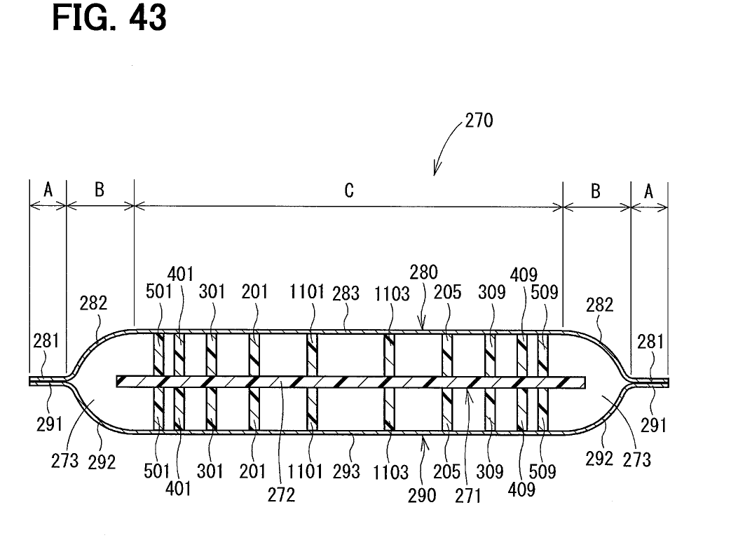

A sixteenth embodiment is illustrated in FIG. 40 to FIG. 42. In the sixteenth embodiment, a resonance restraining device 271 includes first to fifth resilient ribs 100, 200, 300, 400, and 500 extending from a base plate 272 continuously in a circumferential direction of a pulsation damper.

The first to fifth resilient ribs 100, 200, 300, 400, and 500 are formed to have the same thickness, and are arranged concentrically. The intervals of center positions a, b, c, d, and e of the plate-thicknesses of first to fifth resilient ribs 100, 200, 300, 400, and 500 in the radial direction are reduced as it goes radially outward. For example, the gap between the fourth resilient rib 400 and the fifth resilient ribs 500 is smaller than the gap between the first resilient rib 100 and the second resilient rib 200.

Accordingly, the resilient rib provided in a predetermined range α at a center portion of the pulsation dumper 70 is configured to be bent more easily than the resilient rib having the same surface area and provided in a predetermined range β which is radially outside the pulsation dumper 70. Therefore, deformation of the center portion of the pulsation dumper 70 in the plate-thickness direction is not impaired by the resilient rib, so that deformation is easily achieved. Therefore, the resonance restraining device 271 is capable of maintaining a pressure pulsation damping performance of the pulsation dumper 70.

Ease of bending may be adjusted by setting the pitches of the first to fifth resilient ribs 100, 200, 300, 400, and 500. Accordingly, a force of pressing the first to fifth resilient ribs 100, 200, 300, 400, and 500 against diaphragms 280 and 290 can be adjusted. Accordingly, the resonance restraining device 271 is capable of restraining the resonance of the diaphragms 280 and 290.

In the sixteenth embodiment, in addition to the advantageous effect of the above-described first and fifteenth embodiments, the following advantageous effects will be achieved.

In the sixteenth embodiment, the number of the resilient ribs provided in a predetermined range α of a center portion of the pulsation dumper 70 is smaller than the number of the resilient ribs having the same surface area and being provided in a predetermined range β radially outside the pulsation dumper 70. In the sixteenth embodiment, since the thicknesses of a plurality of the resilient ribs are the same, the surface area occupied by the resilient ribs in the predetermined range α is smaller than the surface area occupied by the resilient ribs in the predetermined range β.

Accordingly, the pulsation dumper 70 is capable of maintaining the pressure pulsation damping performance without impairing deformation of the center portions of the diaphragms 280 and 290.

### Seventeenth Embodiment

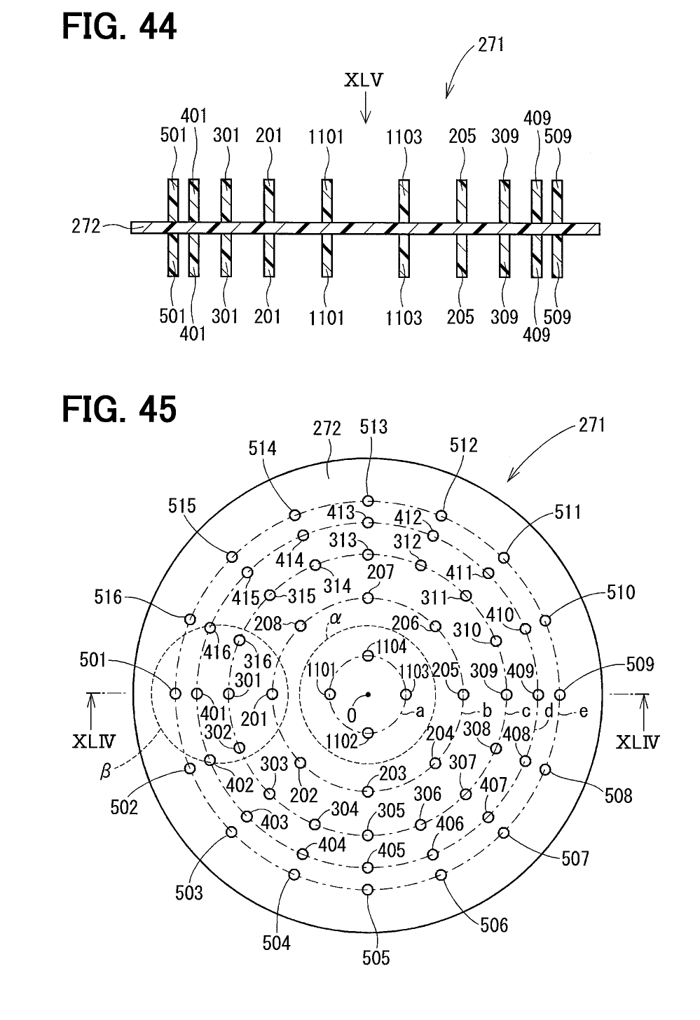

A seventeenth embodiment is illustrated in FIG. 43 to FIG. 45. In the seventeenth embodiment, a resonance restraining device 271 includes first to fifth resilient ribs extending from a base plate 272 intermittently in a circumferential direction of a pulsation damper.

First resilient ribs 101 to 104 include, for example, four resilient ribs.

Second resilient ribs 201 to 208 include, for example, eight resilient ribs.

Third resilient ribs 301 to 316, fourth resilient ribs 401 to 416, and fifth resilient ribs 501 to 516 each include, for example, sixteen resilient ribs.

The first to fifth resilient ribs are not limited to a column shape, but may be a square pole or a fan-shaped pole.

The first to fifth resilient ribs 101 to 104, 201 to 208, 301 to 316, 401 to 416, 501 to 516 are formed to have the same thickness, and are arranged concentrically. In other words, an imaginary line a connecting centers of the first resilient ribs 101 to 104, an imaginary line b connecting centers of the second resilient ribs 201 to 208, an imaginary line c connecting centers of third resilient ribs 301 to 316, an imaginary line d connecting centers of the fourth resilient ribs 401 to 416, and an imaginary line e connecting centers of the fifth resilient ribs 501 to 516 are arranged concentrically.

The intervals of imaginary lines a, b, c, d, e described above of the first to fifth resilient ribs are reduced as it goes radially outward. For example, an interval between an imaginary line d of the assembly of the fourth resilient ribs 401 to 416 and an imaginary line e of the assembly of the fifth resilient ribs 501 to 516 is smaller than an interval between the imaginary line a of the assembly of the first resilient ribs 101 to 104 and the imaginary line b of the assembly of the second resilient ribs 201 to 208.

The number of the resilient ribs provided at a center portion of the pulsation dumper 70 is smaller than the number of the resilient ribs provided at a position radially outside the pulsation dumper 70. For example, the number of the first resilient ribs 101 to 104 is smaller than the number of the fifth resilient ribs 501 to 516.

Accordingly, the assembly of the resilient ribs provided in a predetermined range α of a center portion of the pulsation dumper 70 is configured to be bent more easily than the assembly of the resilient ribs having the same surface area and being provided in a predetermined range β radially outside the pulsation dumper 70. Therefore, deformation of the center portion of the pulsation dumper 70 in the plate thickness direction is not impaired by the resilient ribs 101 to 104, 201 to 208, and 301 to 316, 401 to 416, 501 to 516, so that deformation is easily achieved. Therefore, the resonance restraining device 271 is capable of maintaining a pressure pulsation damping performance of the pulsation dumper 70.

By setting the pitches of the imaginary lines a, b, c, d and e of the first to fifth resilient ribs 101 to 104, 201 to 208, 301 to 316, 401 to 416, 501 to 516 or setting the number of the first to fifth resilient ribs, ease of bending of the same may be adjusted, and a force of pressing the same against the diaphragms 280 and 290 may be adjusted. The resonance restraining device 271 is capable of restraining a resonance of the diaphragms 280 and 290 by pressing the first to fifth resilient ribs 101 to 104, 201 to 208, 301 to 316, 401 to 416, 501 to 516 against a first damper portion 283 and a second damper portion 293.

In the seventeenth embodiment, in addition to the advantageous effect of the above-described first to sixteenth embodiments, the following advantageous effects will be achieved.

In the seventeenth embodiment, the interval between the resilient rib and the resilient rib provided in the predetermined range α at the center portion of the pulsation damper is larger than the interval of the resilient ribs having the same surface area and being provided in a predetermined range β radially outside the pulsation dumper 70. In the seventeenth embodiment, since the thicknesses of a plurality of the resilient ribs are the same, the surface area occupied by the resilient ribs in the predetermined range α is smaller than the surface area occupied by the resilient ribs in the predetermined range β.

Accordingly, the pulsation dumper 70 is capable of maintaining the pressure pulsation damping performance without impairing deformation of the center portions of the diaphragms 280 and 290.

In the above-described embodiments, the damper portion of the pulsation damper has a flat shape. The damper portion of the pulsation damper may have a corrugated shape.

In the above-described embodiment, a plurality of resilient ribs is arranged concentrically. A plurality of the resilient ribs may be arranged at random as long as those arranged at a center portion of the pulsation damper is bent more easily than those arranged radially outside.

In the above-described embodiment, one resonance restraining device 271 having a plurality of resilient ribs is provided in the sealed space 273 of the pulsation dumper 70. A plurality of the resonance restraining devices 271 formed by dividing the base plate 272 in the radial direction may be provided in the sealed space 273 of the pulsation dumper 70.

In the above-described embodiment, by adjusting the intervals of a plurality of resilient ribs in the radial direction or in the circumferential direction, or the thicknesses of a plurality of the resilient ribs, the resilient ribs provided in the predetermined range α are configured to be bent more easily than the resilient ribs provided in the predetermined range β.

By adjusting angles between a plurality of the resilient ribs and the base plate 272, the resilient ribs provided in the predetermined range α may be configured to be bent more easily than the resilient ribs provided in the predetermined range β. In this case, the angle (smaller angle) formed between the resilient rib positioned at a center portion of the pulsation damper and the base plate 272 is set to be smaller than the angle formed between the resilient rib located radially outside the pulsation damper and the base plate 272.

1. A pulsation damper configured to reduce a pressure pulsation of a fuel flowing in a fuel chamber comprising:
a first diaphragm configured to be resiliently deformable by the pressure pulsation of the fuel in the fuel chamber;
a second diaphragm configured to define a sealed space in which a gas having a predetermined pressure is encapsulated in cooperation with the first diaphragm in such a manner as to be resiliently deformable by the pressure pulsation of the fuel in the fuel chamber;
a first resilient member provided in the sealed space and configured to abut against an inner wall of the first diaphragm;
a second resilient member provided in the sealed space and configured to abut against an inner wall of the second diaphragm; and
a supporting member provided between the first resilient member and the second resilient member in such a manner as to support an outer peripheral portion of the first resilient member and an outer peripheral portion of the second resilient member.

2. The pulsation damper according to claim 1, wherein
the first diaphragm includes
a ring-shaped first outer edge portion configured to be joined to an outer edge of the second diaphragm,
a first curved surface portion extending from the ring-shaped first outer edge portion toward a direction away from the second diaphragm, and
a first damper portion provided radially inside the first curved surface portion, the second diaphragm includes
a ring-shaped second outer edge portion configured to be joined to an outer edge of the first diaphragm,
a second curved surface portion extending from the ring-shaped second outer edge portion toward a direction away from the first diaphragm, and
a second damper portion provided radially inside the second curved surface portion,
the first resilient member abuts against a substantially entire area from a vicinity of a connecting point between the first curved surface portion and the first damper portion to the first damper portion,
the second resilient member abuts against a substantially entire area from a vicinity of a connecting point between the second curved surface portion and the second damper portion to the second damper portion.

3. The pulsation damper according to claim 1, wherein
the supporting member is formed to have a length between the first resilient member and the second resilient member or slightly larger than the length,
the supporting member presses the first resilient member against the first diaphragm, and
the supporting member presses the second resilient member against the second diaphragm.

4. The pulsation damper according to claim 1, wherein
the supporting member includes
a plurality of supporting posts arranged along the outer peripheral portions of the first resilient member and the second resilient member, and
coupling portions connecting a plurality of the supporting posts in a circumferential direction.

5. The pulsation damper according to claim 1, wherein
the supporting member abuts against the outer peripheral portions of the first resilient member and the second resilient member continuously in the circumferential direction.

6. The pulsation damper according to claim 5, wherein
the supporting member includes a passage which communicates a space radially inside the supporting member in the sealed space and a space radially outside the supporting member in the sealed space.

7. The pulsation damper according to claim 1, wherein
the first resilient member includes a first projecting portion projecting toward the second resilient member,
the second resilient member includes a second projecting portion projecting toward the first resilient member, and
each of the first projecting portion and the second projecting portion is provided radially inside or radially outside the supporting member to prevent a positional displacement in the radial direction of the supporting member.

8. The pulsation damper according to claim 1, wherein
the supporting member is formed of a resilient member.

9. The pulsation damper according to claim 1, wherein
the first resilient member, the second resilient member, and the supporting member are formed of different materials from each other.

10. A high-pressure pump comprising:
a plunger;
a pump body including a pump chamber in which fuel is pressurized by a reciprocal movement of the plunger;
a fuel chamber communicating with the pump chamber; and
a pulsation damper according to claim 1 configured to be capable of reducing a pressure pulsation of the fuel discharged from the pump chamber to the fuel chamber.

11. A pulsation damper configured to reduce a pressure pulsation of a fuel flowing in a fuel chamber comprising:
a first diaphragm configured to be resiliently deformable by the pressure pulsation of the fuel in the fuel chamber;
a second diaphragm configured to define a sealed space in which a gas having a predetermined pressure is encapsulated in cooperation with the first diaphragm, the second diaphragm being configured to be resiliently deformable by the pressure pulsation of the fuel in the fuel chamber;
a first inscribed member provided in the sealed space, the first inscribed member including a first resilient portion configured to abut an inner wall of the first diaphragm, a second resilient portion configured to abut against an inner wall of the second diaphragm, and a first supporting portion configured to support an outer peripheral portion of the first resilient portion and an outer peripheral portion of the second resilient portion; and
a second inscribed member including a third resilient portion configured to abut against an inner wall of the first diaphragm, a fourth resilient portion configured to abut against an inner wall of the second diaphragm, and a second supporting portion configured to support an outer peripheral portion of the third resilient portion and an outer peripheral portion of the fourth resilient portion, the second inscribed member being configured to be combined with the first inscribed member in the radial direction of the pulsation damper and provided in the sealed space.

12. The pulsation damper according to claim 11, wherein
the first inscribed member includes
a first projecting portion extending toward the second inscribed member, and
a first depressing portion depressing in a direction away from the second inscribed member, and
the second inscribed member includes
a second projecting portion extending toward the first inscribed member to be combined with the first depressing portion, and
a second depressing portion depressed in a direction away from the first inscribed member to be combined with the first projecting portion.

13. The pulsation damper according to claim 11, wherein
the first diaphragm includes a ring-shaped first outer edge portion configured to be joined to an outer edge of the second diaphragm, a first curved surface portion extending from the outer edge portion toward a direction away from the second diaphragm, and a first damper portion provided radially inside the first curved surface portion,
the second diaphragm includes a ring-shaped second outer edge portion configured to be joined to an outer edge of the first diaphragm, a second curved surface portion extending from the second outer edge portion in the direction away from the first diaphragm, and a second damper portion provided radially inside the second curved surface portion,
the first resilient portion and the third resilient portion abut against a substantially entire area from the vicinity of the connecting point between the first damper portion and the first curved surface portion to the first damper portion, and
the second resilient portion and the fourth resilient portion abut against a substantially entire area from the vicinity of a connecting point between the second damper portion and the second curved surface portion to the second damper portion.

14. The pulsation damper according to claim 11, wherein
at least one of the first supporting portion and the second supporting portion includes a passage extending in a radial direction.

15. The pulsation damper according to claim 11, wherein
the first inscribed member and the second inscribed member have the same shape.

16. The pulsation damper according to claim 11, further comprising:
a third inscribed member including a fifth resilient portion configured to abut against an inner wall of the first diaphragm, a sixth resilient portion configured to abut against an inner wall of the second diaphragm, and a third supporting portion configured to support an outer peripheral portion of the fifth resilient portion and an outer peripheral portion of the sixth resilient portion, wherein
the third inscribed member is configured to abut against the first inscribed member and the second inscribed member in the circumferential direction of the pulsation damper in the sealed space, and
the first inscribed member, the second inscribed member, and the third inscribed member are combined with each other in such a manner that a center of the pulsation damper is a boundary of the first inscribed member, the second inscribed member, and the third inscribed member.

17. The pulsation damper according to claim 11, wherein
the first inscribed member includes a first rib extending radially inward from the first supporting portion for supporting the first resilient portion and the second resilient portion, and
the second inscribed member includes a second rib extending radially inward from the second supporting portion for supporting the third resilient portion and the fourth resilient portion.

18. A high-pressure pump comprising:
a plunger;
a pump body including a pump chamber in which fuel is pressurized by a reciprocal movement of the plunger, and a fuel chamber communicating with the pump chamber; and
a pulsation damper according to claim 11 configured to be capable of reducing a pressure pulsation of the fuel discharged from the pump chamber to the fuel chamber.

19. A pulsation damper configured to reduce a pressure pulsation of fuel flowing in a fuel chamber comprising:
a first diaphragm configured to be resiliently deformable by the pressure pulsation of the fuel in the fuel chamber;
a second diaphragm configured to define a sealed space in which gas having a predetermined pressure is encapsulated in cooperation with the first diaphragm, the second diaphragm being configured to be resiliently deformable by the pressure pulsation of the fuel in the fuel chamber; and
a resonance restraining device integrally including a base plate provided in the sealed space, and a plurality of resilient ribs extending from the base plate in such a manner as to press an inner wall of the first diaphragm and an inner wall of the second diaphragm.

20. The pulsation damper according to claim 19, wherein
the resilient ribs provided in a predetermined range at a center portion of the pulsation damper is bent more easily than the resilient ribs which have the same surface area and are provided in another predetermined range radially outside the pulsation damper.

21. The pulsation damper according to claim 19, wherein
a surface area of the resilient ribs provided in the predetermined range at the center portion of the pulsation damper abutting against the first diaphragm and the second diaphragm is smaller than a surface area of the resilient ribs thereof which have the same surface area and are provided in the predetermined range radially outside the pulsation damper abutting against the first diaphragm and the second diaphragm.

22. The pulsation damper according to claim 19, wherein
the first diaphragm includes a ring-shaped first outer edge portion configured to be joined to an outer edge of the second diaphragm, a first curved surface portion extending from the first outer edge portion toward a direction away from the second diaphragm, and a first damper portion provided radially inside the first curved surface portion,
the second diaphragm includes a ring-shaped second outer edge portion configured to be joined to an outer edge of the first diaphragm, a second curved surface portion extending from the second outer edge portion in the direction away from the first diaphragm, and a second damper portion provided radially inside the second curved surface portion, and
a plurality of the resilient ribs are provided radially inside the first curved surface portion and the second curved surface portion in such a manner as to press an inner wall of the first damper portion and an inner wall of the second damper portion.

23. The pulsation damper according to claim 19, wherein
a thickness of the resilient rib provided in the predetermined range at the center portion of the pulsation damper is smaller than a thickness of the resilient rib which has the same surface area and is provided within the predetermined range radially outside the pulsation damper.

24. The pulsation damper according to claim 19, wherein
the number of the resilient ribs provided in the predetermined range at the center portion of the pulsation damper is smaller than the number of the resilient ribs which have the same surface area and are provided within the predetermined range radially outside the pulsation damper.

25. The pulsation damper according to claim 19, wherein
an interval of the resilient ribs provided in the predetermined range at the center portion of the pulsation damper is larger than an interval of the resilient ribs which have the same surface area and are provided within the predetermined range radially outside the pulsation damper.

26. The pulsation damper according to claim 19, wherein
the resilient ribs are provided continuously in the circumferential direction of the pulsation damper.

27. The pulsation damper according to claim 19, wherein
the resilient ribs are provided intermittently in the circumferential direction of the pulsation damper.

28. The pulsation damper according to claim 19, wherein
the resilient ribs are provided at positions other than the center of the pulsation damper.

29. A high pressure pump comprising:
a plunger;
a pump body including a pump chamber in which a fuel is pressurized by a reciprocal movement of the plunger,
a fuel chamber communicating with the pump chamber; and
a pulsation damper according to claim 19 configured to be capable of reducing a pressure pulsation of the fuel discharged from the pump chamber to the fuel chamber.
